(19) United States
(12) Patent Application Publication
(10) Pub. No.: US 2010/0048516 A1
(43) Pub. Date: Feb. 25, 2010

(54) PENETRATION ENHANCER FOR FUNGICIDES

(75) Inventors: Peter Baur, Schondorf (DE); Ronald Vermeer, Leverkusen (DE); Rainer Suessmann, Heinrich-Fendel (DE)

Correspondence Address: Baker Donelson Bearman, Caldwell & Berkowitz, PC, 555 Eleventh Street, NW, Sixth Floor, Washington, DC, 20004, US

(73) Assignee: Bayer CropScience AG, Monheim (DE)

(21) Appl. No.: 12/519,744

(22) PCT Filed: Dec. 7, 2007
(86) PCT No.: PCT/EP07/10643

§ 371 Date: Aug. 12, 2009

(30) Foreign Application Priority Data
Dec. 18, 2006 (EP) 06026145.0

(51) Int. Cl. A01N 57/10; A01P 3/00

(52) U.S. Cl. 514/143

(57) ABSTRACT

The invention relates to the field of chemical plant protection, in particular the use of a specific compound as a penetration enhancer for agrochemical active substances selected from the group consisting of the herbicides and safeners. The compound is tributoxyethyl phosphate (TBEP).

The invention relates to the field of chemical crop protection, in particular the use of a specific compound as a penetration enhancer for agrochemical active substances selected from the group consisting of the herbicides and safeners and crop protection agents containing this compound. The compound is tributoxyethyl phosphate (CAS reg. no.: 78-51-3; referred to below as TBEP).

The enhancement of penetration of herbicides and safeners in plants is brought about by ‘penetration enhancers’. The term penetration enhancer is understood as meaning compounds which accelerate the uptake of herbicides and safeners, alone or as a mixture, through the cuticle of a plant into the plant, i.e. the rate of uptake, and/or increase the amount of active substance absorbed into the plant.

Substances which increase the penetration of herbicides and/or safeners through the cuticle of the plant are valuable auxiliaries in chemical crop protection. Various classes of substances are already known as penetration enhancers (cf. for example WO 2005/104844 A). DE 3513889 A1 generally discusses penetration enhancers as an “activator” for biocides and EP 579052 A2 describes compounds selected from the group consisting of alkyl phosphates, such as tributyl phosphate and tripropyl phosphate, as penetration enhancers. Nevertheless, from various points of view, there is still a need for further compounds having more advantageous properties.

It is therefore an object of the invention to provide further advantageous substances having penetration-enhancing properties for agrochemical active substances.

It has now surprisingly been found that the solvent TBEP, in contrast to many other solvents, is suitable in certain relatively low application rates and in certain mixing ratios to the active substance for increasing the penetration of herbicides and safeners, alone or as a mixture, through the cuticle of the plant and thus for increasing the biological action of crop protection agents.

TBEP is already known as a solvent at appropriately high application rates in crop protection, such as in herbicides (cf. for example WO 01/47356 A1, EP 1251736 B1, WO 00/56146 A1, EP 1164842 B1) and insecticides (cf. for example JP 08291004 A, U.S. Pat. No. 5,674,517 A). GB 2022070 A discloses TBEP for defoliation, it being added in ratios (TBEP: active substance) of from 2:1 to 4:1 to herbicidal active substances. In the field of fungicides, the use of TBEP as a penetration enhancer appears to be as yet unknown.

The invention relates to a method for enhancing penetration, the components
(A) one or more active substances selected from the group consisting of the herbicides and/or safeners,
(B) tributoxyethyl phosphate (TBEP) in doses of from 2.5 to 150.0 g/ha and
(C) optionally one or more emulsifiers, preferably selected from the group consisting of the ionic and nonionic emulsifiers and mixtures thereof having HLB values of from 10 to 17,
   being applied simultaneously or sequentially to the harmful plants.

The invention also relates to the use of the method described here, the components being applied simultaneously or sequentially to the harmful plants.

Since the action mechanism of TBEP as a penetration enhancer is in principle independent of the type of agrochemical active substance used, all active substances selected from the group consisting of the herbicides, whose biological activity against weeds in the wider sense, referred to below as harmful plants, can be increased by greater penetration into the harmful plant, are suitable. In the case of the active substances selected from the group consisting of the safeners, greater penetration into the crop plant is desired so that the protective effect can be increased.

Active substances selected from the group consisting of the herbicides, also comprising plant growth regulators, and selected from the group consisting of the safeners, and plant nutrients which have systemic properties and contact agents suitable as combination partners may preferably be mentioned. Below, the term herbicides includes both herbicides and plant growth regulators, unless evident otherwise from the context.

Also preferably within the abovementioned groups are systemic active substances, i.e. those which are taken up by the plant through the leaves or via the roots and are distributed in the sap stream, the transport system or plant. Particularly preferred active substances are those which have a log P value≦4 (determined according to EEC Directive 79/831 Annex V. A8 by HPLC, gradient method, acetonitrile/0.1% aqueous phosphoric acid), in particular those having a log P value of ≦4 and ≧0.1.

Examples of individual active substances selected from the group consisting of the herbicides, also including plant growth regulators, and selected from the group consisting of the safeners are:

### Herbicides

Examples of herbicides are, for example, ALS inhibitors (acetolactate synthetase inhibitors) or herbicides selected from the group consisting of the carbamates, thiocarbamates, haloacetanilides, substituted phenoxy, naphthoxy and phenoxyphenoxycarboxylic acid derivatives and heteroaryloxyphenoxyalkanecarboxylic acid derivatives, such as quinolyloxy-, quinoxalyloxy-, pyridyloxy-, benzoxazolyloxy- and benzthiazolyloxyphenoxyalkanecarboxylic esters, cyclohexanedione derivatives, imidazolinones, phosphorus-containing herbicides, for example of the glufosinate type or of the glyphosphate type, pyrimidinyloxypyridinecarboxylic acid derivatives, pyrimidyloxybenzoic acid derivatives, triazolopyrimidine sulfonamide derivatives and S—(N-aryl-N-alkylcarbamoylmethyl)dithiophosphoric esters, ureas and hydroxy-benzonitriles.

In the case of the herbicidal active substances selected from the group consisting of the ALS inhibitors, such as sulfonylureas, not only the neutral compounds but also the salts thereof with inorganic and/or organic counterions are always to be understood in the context of the present invention. Thus, for example, sulfonylureas can form, for example, salts in which the hydrogen of the —SO₂—NH-group is replaced by a cation suitable for agriculture. These salts are, for example, metal salts, in particular alkali metal salts or alkaline earth metal salts, in particular sodium and potassium salts, or ammonium salts or salts with organic amines. The salt formation can also be effected by an addition reaction of an acid with basic groups, such as, for example, amino or alkylamino. Suitable acids for this purpose are strongly inorganic and organic acids, for example HCl, HBr, H₂SO₄ or HNO₃.

A) Preferred ALS inhibitors originate from the series consisting of the sulfonylureas and/or their salts, e.g. pyrimidine- or triazinylaminocarbonyl-[benzene-, pyridine-, pyrazole-, thiophene- and (alkylsulfonyl)alkylamino]sulfamides. Such suitable sulfonylureas are, for example,
A1) phenyl- and benzylsulfonylureas and related compounds, e.g.
1-(2-chlorophenylsulfonyl)-3-(4-methoxy-6-methyl-1,3,5-triazin-2-yl)urea (chlorsulfuron),
1-(2-ethoxycarbonylphenylsulfonyl)-3-(4-chloro-6-methoxypyrimidin-2-yl)urea (chlorimuron-ethyl),
1-(2-methoxyphenylsulfonyl)-3-(4-methoxy-6-methyl-1,3,5-triazin-2-yl)urea (metsulfuron-methyl),
1-(2-chloroethoxyphenylsulfonyl)-3-(4-methoxy-6-methyl-1,3,5-triazin-2-yl)urea (triasulfuron),
1-(2-methoxycarbonylphenylsulfonyl)-3-(4,6-dimethylpyrimidin-2-yl)urea (sulfumeturon-methyl),
1-(2-methoxycarbonylphenylsulfonyl)-3-(4-methoxy-6-methyl-1,3,5-triazin-2-yl)-3-methylurea (tribenuron-methyl),
1-(2-methoxycarbonylbenzylsulfonyl)-3-(4,6-dimethoxypyrimidin-2-yl)urea (bensulfuron-methyl),
1-(2-methoxycarbonylphenylsulfonyl)-3-(4,6-bis(difluoromethoxy)pyrimidin-2-yl)urea (primisulfuron-methyl),
3-(4-ethyl-6-methoxy-1,3,5-triazin-2-yl)-1-(2,3-dihydro-1,1-dioxo-2-methylbenzo[b]thiophene-7-sulfonyl)urea (EP-A 0 079 683),
3-(4-ethoxy-6-ethyl-1,3,5-triazin-2-yl)-1-(2,3-dihydro-1,1-dioxo-2-methylbenzo[b]thiophene-7-sulfonyl)urea (EP-A 0 079 683),
3-(4-methoxy-6-methyl-1,3,5-triazin-2-yl)-1-(2-methoxycarbonyl-5-iodophenylsulfonyl)urea (iodosulfuron-methyl and the sodium salt thereof, WO 92/13845), DPX-66037, triflusulfuron-methyl (cf. Brighton Crop Prot. Conf.—Weeds—1995, page 853),
CGA-277476 (cf. Brighton Crop Prot. Conf.—Weeds—1995, page 79),
methyl 2-[3-(4,6-dimethoxypyrimidin-2-yl)ureidosulfonyl]-4-methanesulfon-amidomethylbenzoate (mesosulfuron-methyl, WO 95/10507),
N,N-dimethyl-2-[3-(4,6-dimethoxypyrimidin-2-yl)ureidosulfonyl]-4-formyl-aminobenzamide (foramsulfuron, WO 95/01344);
   A2) thienylsulfonylureas, e.g.
1-(2-methoxycarbonylthiophen-3-yl)-3-(4-methoxy-6-methyl-1,3,5-triazin-2-yl)urea (thifensulfuron-methyl);
   A3) pyrazolylsulfonylureas, e.g.
1-(4-ethoxycarbonyl-1-methylpyrazol-5-ylsulfonyl)-3-(4,6-dimethoxypyrimidin-2-yl)urea (pyrazosulfuron-methyl);
methyl 3-chloro-5-(4,6-dimethoxypyrimidin-2-ylcarbamoylsulfamoyl)-1-methyl-pyrazol-4-ylcarboxylate (EP-A 0 282 613);
methyl 5-(4,6-dimethylpyrimidin-2-ylcarbamoylsulfamoyl)-1-(2-pyridyl)pyrazol-4-ylcarboxylate (NC-330, cf. Brighton Crop Prot. Conference ‘Weeds’ 1991, vol. 1, page 45 et seq.),
DPX-A8947, azimsulfuron (cf. Brighton Crop Prot. Conf. ‘Weeds’ 1995, page 65);
   A4) sulfondiamide derivatives, e.g.
3-(4,6-dimethoxypyrimidin-2-yl)-1-(N-methyl-N-methylsulfonylaminosulfonyl) urea (amidosulfuron) and the structural analogs thereof (EP-A 0 131 258 and Z. Pfl. Krankh. Pfl. Schutz, special issue XII, 489-497 (1990));
   A5) pyridylsulfonylureas, e.g.
1-(3-N,N-dimethylaminocarbonylpyridin-2-ylsulfonyl)-3-(4,6-dimethoxypyrimidin-2-yl)urea (nicosulfuron),
1-(3-ethylsulfonylpyridin-2-ylsulfonyl)-3-(-(4,6-dimethoxypyrimidin-2-yl)urea (rimsulfuron),
methyl 2-[3-(4,6-dimethoxypyrimidin-2-yl)ureidosulfonyl]-6-trifluoromethyl-3-pyridinecarboxylate, sodium salt (DPX-KE 459, flupyrsulfuron, cf. Brighton Crop Prot. Conf. Weeds, 1995, page 49),
pyridylsulfonylureas, as described, for example, in DE-A 40 00 503 and DE-A 40 30 577, preferably those with the formula

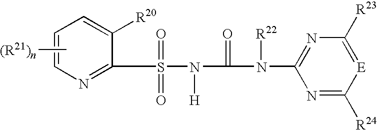

in which
E is CH or N, preferably CH,
R²⁰ is iodine or NR²⁵R²⁶,
R²¹ is hydrogen, halogen, cyano, (C₁-C₃)-alkyl, (C₁-C₃)-alkoxy, (C₁-C₃)-haloalkyl, (C₁-C₃)-haloalkoxy, (C₁-C₃)-alkylthio, (C₁-C₃)-alkoxy-(C₁-C₃)-alkyl, (C₁-C₃)-alkoxycarbonyl, mono- or di-((C₁-C₃)-alkyl)-amino, (C₁-C₃)-alkylsulfinyl or sulfonyl, SO₂—NR^{x}R^{y} or CO—NR^{x}R^{y}, in particular hydrogen,
R^{x}, R^{y}, independently of one another, are hydrogen, (C₁-C₃)-alkyl, (C₁-C₃)-alkenyl, (C₁-C₃)-alkynyl or together are —(CH₂)₄—, —(CH₂)₅— or —(CH₂)₂—O—(CH₂)₂—,
n is 0, 1, 2 or 3, preferably 0 or 1,
R²² is hydrogen or CH₃,
R²³ is halogen, (C₁-C₂)-alkyl, (C₁-C₂)-alkoxy, (C₁-C₂)-haloalkyl, in particular CF₃, (C₁-C₂)-haloalkoxy, preferably OCHF₂ or OCH₂CF₃,
R²⁴ is (C₁-C₂)-alkyl, (C₁-C₂)-haloalkoxy, preferably OCHF₂, or (C₁-C₂)-alkoxy,
R²⁵ is (C₁-C₄)-alkyl,
R²⁶ is (C₁-C₄)-alkylsulfonyl or
R²⁵ and R²⁶ together are a chain of the formula —(CH₂)₃SO₂— or —(CH₂)₄SO₂—, e.g. 3-(4,6-dimethoxypyrimiden-2-yl)-1-(3-N-methylsulfonyl-N-methylaminopyridin-2-yl)sulfonylurea, or salts thereof;
   A6) alkoxyphenoxysulfonylureas, as described, for example, in EP-A 0 342 569, preferably those of the formula

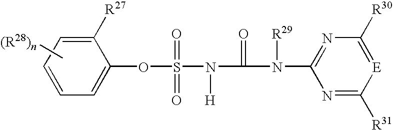

in which
E is CH or N, preferably CH,
R²⁷ is ethoxy, propoxy or isopropoxy,
R²⁸ is halogen, NO₂, CF₃, CN, (C₁-C₄)-alkyl, (C₁-C₄)-alkoxy, (C₁-C₄)-alkylthio or (C₁-C₃)-alkoxycarbonyl, preferably in the 6-position on the phenyl ring,
n is 0, 1, 2 or 3, preferably 0 or 1,
R²⁹ is hydrogen, (C₁-C₄)-alkyl or (C₃-C₄)-alkenyl,
R³⁰, R³¹, independently of one another, are halogen, (C₁-C₂)-alkyl, (C₁-C₂)-alkoxy, (C₁-C₂)-haloalkyl, (C₁-C₂)-haloalkoxy or (C₁-C₂)-alkoxy-(C₁-C₂)-alkyl, preferably OCH₃ or CH₃, e.g. 3-(4,6-dimethoxypyrimidin-2-yl)-1-(2-ethoxyphenoxy)sulfonylurea, or salts thereof;
   A7) imidazolylsulfonylureas, e.g.
MON 37500, sulfosulfuron (cf. Brighton Crop Prot. Conf. ‘Weeds’, 1995, page: 57), and other related sulfonylurea derivatives and mixtures thereof;
typical representatives of these active substances are, inter alia, the compounds mentioned below: amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl-sodium, halosulfuron-methyl, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, triflusulfuron-methyl, iodosulfuron-methyl and the sodium salt thereof (WO 92/13845), mesosulfuron-methyl and the sodium salt thereof (Agrow no. 347, Mar. 3, 2000, page 22 (PJB Publications Ltd., 2000)) and foramsulfuron and the sodium salt thereof (Agrow no. 338, Oct. 15, 1999, page 26 (PJB Publications Ltd., 2000)).
   B) Herbicides of the type consisting of the phenoxyphenoxy- and heteroaryloxyphenoxycarboxylic acid derivatives, such as
   B1) phenoxyphenoxy- and benzyloxyphenoxycarboxylic acid derivatives, e.g.
methyl 2-(4-(2,4-dichlorophenoxy)phenoxy)propionate (diclofop-methyl),
methyl 2-(4-(4-bromo-2-chlorophenoxy)phenoxy)propionate (DE-A 26 01 548),
methyl 2-(4-(4-bromo-2-fluorophenoxy)phenoxy)propionate (U.S. Pat. No. 4,808,750),
methyl 2-(4-(2-chloro-4-trifluoromethylphenoxy)phenoxy)propionate (DE-A 24 33 067),
methyl 2-(4-(2-fluoro-4-trifluoromethylphenoxy)phenoxy)propionate (U.S. Pat. No. 4,808,750),
methyl 2-(4-(2,4-dichlorobenzyl)phenoxy)propionate (DE-A 24 17 487),
ethyl 4-(4-(4-trifluoromethylphenoxy)phenoxy)pent-2-enoate,
methyl 2-(4-(4-trifluoromethylphenoxy)phenoxy)propionate (DE-A 24 33 067);
   B2) “mononuclear” heteroaryloxyphenoxyalkanecarboxylic acid derivatives, e.g.
ethyl 2-(4-(3,5-dichloropyridyl-2-oxy)phenoxy)propionate (EP-A 0 002 925),
propargyl 2-(4-(3,5-dichloropyridyl-2-oxy)phenoxy)propionate (EP-A 0 003 114),
methyl 2-(4-(3-chloro-5-trifluoromethyl-2-pyridyloxy)phenoxy)propionate (EP-A 0 003 890),
ethyl 2-(4-(3-chloro-5-trifluoromethyl-2-pyridyloxy)phenoxy)propionate (EP-A 0 003 890),
propargyl 2-(4-(5-chloro-3-fluoro-2-pyridyloxy)phenoxy)propionate (EP-A 0 191 736), butyl 2-(4-(5-trifluoromethyl-2-pyridyloxy)phenoxy)propionate (fluazifop-butyl);
   B3) “dinuclear” heteroaryloxyphenoxyalkanecarboxylic acid derivatives, e.g.
methyl and ethyl 2-(4-(6-chloro-2-quinoxalyloxy)phenoxy)propionate (quizalofopmethyl and quizalofopethyl),
methyl 2-(4-(6-fluoro-2-quinoxalyloxy)phenoxy)propionate (cf. J. Pest. Sci. vol. 10, 61 (1985)),
isopropylideneaminooxyethyl 2-(4-(6-chloro-2-quinoxalyloxy)phenoxy)propionate (propaquizafop),
ethyl 2-(4-(6-chlorobenzoxazol-2-yloxy)phenoxy)propionate (fenoxaprop-ethyl), the D(+) isomer thereof (fenoxaprop-P-ethyl) and ethyl 2-(4-(6-chlorobenzthiazol-2-yloxy)phenoxy)propionate (DE-A 26 40 730),
tetrahydro-2-furylmethyl 2-(4-(6-chloroquinoxalyloxy)phenoxy)propionate (EP-A 0 323 727);
   C) chloroacetanilides, e.g.
N-methoxymethyl-2,6-diethylchloroacetanilide (alachlor),
N-(3-methoxyprop-2-yl)-2-methyl-6-ethylchloroacetanilide (metolachlor),
N-(3-methyl-1,2,4-oxadiazol-5-ylmethyl)chloroacetic acid 2,6-dimethylanilide,
N-(2,6-dimethylphenyl)-N-(1-pyrazolylmethyl)chloroacetamide (metazachlor);
   D) thiocarbamates, e.g.
S-ethyl N,N-dipropylthiocarbamate (EPTC),
S-ethyl N,N-diisobutylthiocarbamate (butylate);
   E) cyclohexanedione oximes, e.g.
methyl 3-(1-allyloxyiminobutyl)-4-hydroxy-6,6-dimethyl-2-oxocyclohex-3-enecarboxylate (alloxydim),
2-(1-ethoxyiminobutyl)-5-(2-ethylthiopropyl)-3-hydroxycyclohex-2-en-1-one (sethoxydim),
2-(1-ethoxyiminobutyl)-5-(2-phenylthiopropyl)-3-hydroxycyclohex-2-en-1-one (cloproxydim),
2-(1-(3-chloroallyloxy)iminobutyl)-5-(2-ethylthiopropyl)-3-hydroxycyclohex-2-en-1-one,
2-(1-(3-chloroallyloxy)iminopropyl)-5-(2-ethylthiopropyl)-3-hydroxycyclohex-2-en-1-one (clethodim),
2-(1-ethoxyiminobutyl)-3-hydroxy-5-(thian-3-yl)cyclohex-2-enone (cycloxydim),
2-(1-ethoxyiminopropyl)-5-(2,4,6-trimethylphenyl)-3-hydroxycyclohex-2-en-1-one (tralkoxydim);
   F) imidazolinones, e.g.
methyl 2-(4-isopropyl-4-methyl-5-oxo-2-imidazolin-2-yl)-5-methylbenzoate and
2-(4-isopropyl-4-methyl-5-oxo-2-imidazolin-2-yl)-4-methylbenzoic acid (imazamethabenz),
5-ethyl-2-(4-isopropyl-4-methyl-5-oxo-2-imidazolin-2-yl)pyridine-3-carboxylic acid (imazethapyr),
2-(4-isopropyl-4-methyl-5-oxo-2-imidazolin-2-yl)quinoline-3-carboxylic acid (imazaquin),
2-(4-isopropyl-4-methyl-5-oxo-2-imidazolin-2-yl)pyridine-3-carboxylic acid (imazapyr),
5-methyl-2-(4-isopropyl-4-methyl-5-oxo-2-imidazolin-2-yl)pyridine-3-carboxylic acid (imazethamethapyr);
   G) triazolopyrimidinesulfonamide derivatives, e.g.
N-(2,6-difluorophenyl)-7-methyl-1,2,4-triazolo[1,5-c]pyrimidin-2-sulfonamide (flumetsulam),
N-(2,6-dichloro-3-methylphenyl)-5,7-dimethoxy-1,2,4-triazolo[1,5-c]pyrimidine-2-sulfonamide,
N-(2,6-difluorophenyl)-7-fluoro-5-methoxy-1,2,4-triazolo[1,5-c]pyrimidine-2-sulfonamide,
N-(2,6-dichloro-3-methylphenyl)-7-chloro-5-methoxy-1,2,4-triazolo[1,5-c]pyrimidine-2-sulfonamide,
N-(2-chloro-6-methoxycarbonyl)-5,7-dimethyl-1,2,4-triazolo[1,5-c]pyrimidine-2-sulfonamide (EP-A 0 343 752, U.S. Pat. No. 4,988,812);
   H) benzoylcyclohexanediones, e.g.
2-(2-chloro-4-methylsulfonylbenzoyl)cyclohexane-1,3-dione (SC-0051, EP-A 0 137 963), 2-(2-nitrobenzoyl)-4,4-dimethylcyclohexane-1,3-dione (EP-A 0 274 634),
2-(2-nitro-3-methylsulfonylbenzoyl)-4,4-dimethylcyclohexane-1,3-dione (WO 91/13548);
   I) pyrimidinyloxypyridinecarboxylic acid or pyrimidinyloxybenzoic acid derivatives, e.g.
benzyl 3-(4,6-dimethoxypyrimidin-2-yl)oxypyridine-2-carboxylate (EP-A 0 249 707),
methyl 3-(4,6-dimethoxypyrimidin-2-yl)oxypyridine-2-carboxylate (EP-A 0 249 707),
2,6-bis[(4,6-dimethoxypyrimidin-2-yl)oxy]benzoic acid (EP-A 0 321 846),
1-(ethoxycarbonyloxyethyl) 2,6-bis[(4,6-di methoxypyrimidin-2-yl)oxy]benzoate (EP-A 0 472 113);
   J) S—(N-aryl-N-alkylcarbamoylmethyl) dithiophosphonic esters, such as S—[N-(4-chlorophenyl)-N-isopropylcarbamoylmethyl]-O,O-dimethyl dithiophosphate (anilophos).
   K) alkylazines, for example as described in WO-A 97/08156, WO-A-97/31904, DE-A-1 9826670, WO-A-98/15536, WO-A-98/15537, WO-A-98/15538, WO-A-98/15539 and also DE-A-19828519, WO-A-98/34925, WO-A-98/42684, WO-A-99/18100, WO-A-99/19309, WO-A-99/37627 and WO-A-99/65882, preferably those of the formula (K)

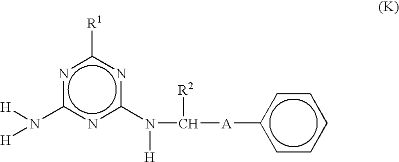

in which
R¹ is (C₁-C₄)-alkyl or (C₁-C₄)-haloalkyl;
R² is (C₁-C₄)-alkyl, (C₃-C₆)-cycloalkyl or (C₃-C₆)-cycloalkyl-(C₁-C₄)-alkyl and
A is —CH₂—, —CH₂—CH₂—, —CH₂—CH₂—CH₂—, —O—, —CH₂—CH₂—O—, —CH₂—CH₂—CH₂—O—, particularly preferably those in the formula K1-K7

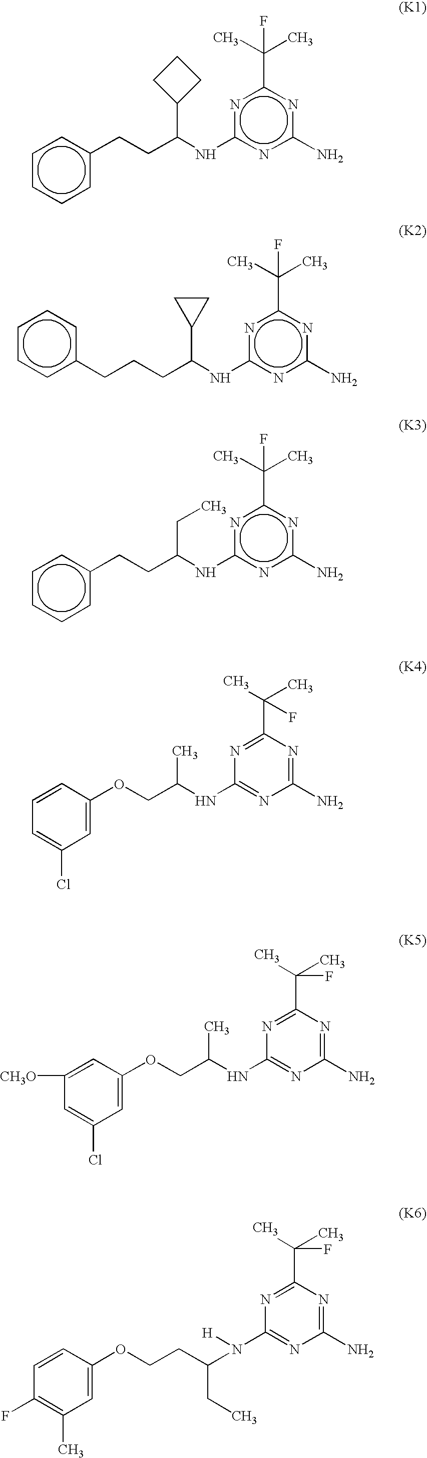

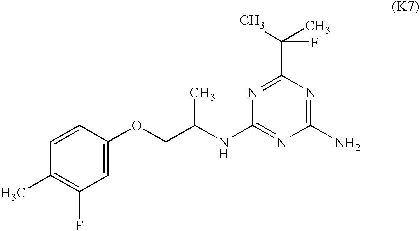

L) phosphorus-containing herbicides, for example one or more compounds of the formula (IV) or derivatives thereof, such as salts,

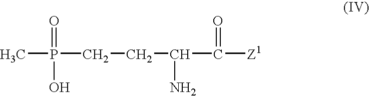

in which
Z¹ is a radical of the formula —OM, —NHCH(CH₃)CONHCH(CH₃)CO₂M or —NHCH(CH₃)CONHCH[CH₂CH(CH₃)₂]CO₂M and
M is H or a salt-forming cation,
and/or one or more compounds of the formula (V) or derivatives thereof, such as salts,

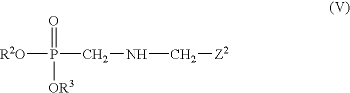

in which
Z² is a radical of the formula CN or CO₂R¹, in which R¹ is Q or a salt-forming cation and Q is H, alkyl, alkenyl, alkoxyalkyl or C₆-C₁₀-aryl which is unsubstituted or substituted and preferably unsubstituted or substituted by one or more radicals selected from the group consisting of alkyl, alkoxy, halogen, CF₃, NO₂ and CN, and
R², R³, in each case independently of one another, are H, alkyl, C₆-C₁₀-aryl, which is unsubstituted or substituted and preferably unsubstituted or substituted by one or more radicals selected from the group consisting of alkyl, alkoxy, halogen, CF₃, NO₂ and CN, or biphenyl or a salt-forming cation.
Examples of active substances of the formulae (IV) and (V) are the following
glufosinate and the ammonium salt thereof in racemic form, i.e. 2-amino-4-[hydroxy(methyl)phosphinoyl]butanoic acid or the ammonium salt thereof,
the L-enantiomer of glufosinate and the ammonium salt thereof,
bilanafos/bialaphos, i.e. L-2-amino-4-[hydroxy(methyl)phosphinoyl]butanoyl-L-alaninyl-L-alanine and the sodium salt thereof,
glyphosate.
   M) carbamates, e.g. asulam, carbetamide, chloropham and propham;
   N) benzofurans, e.g. benfuresate and ethofumesate;
   O) phytohormones;
   P) auxines and auxine analogs, e.g. 4-indole-3-butyric acid, indol-3-acetic acid, 1-naphthylacetic acid, 2-(1-naphthyl)acetamide and 2-naphthyloxyacetic acid;
   Q) zytokinins, e.g. cythokinin, kinetin and 6-benzylaminopurine;
   R) gibberellins, e.g. gibberillic acid, gibberillin A4 and A7;
   S) abscisic acid and derivatives thereof;
   T) ethylene precursors, e.g. ethephon;
   U) herbicides selected from the group consisting of the fatty acid synthetase inhibitors;
   V) ureas, e.g. chlorotoluron, dimefuron, diuron, fluometuron, isoproturon, isouron, karbutilate, linuron, methabenzthiazuron, metobenzuron, metoxuron, monolinuron, neburon, siduron and tebuthiuron and
   W) metamitron.
   X) hydroxybenzonitriles, for example such as bromoxynil and ioxynil and salts and esters thereof, such as bromoxynil octanoate and ioxynil octanoate.

The agrochemical active substances may also be growth regulators. Examples of these are ethephon, tribufos, cyclanilide and thidiazuron.

The herbicides (plant growth regulators) of groups A to X are disclosed, for example, in the documents mentioned above in each case and/or in “The Pesticide Manual”, 12th edition (2000) to 14th edition (2006), The British Crop Protection Council, “Agricultural Chemicals Book II—Herbicides —”, by W. T. Thompson, Thompson Publications, Fresno Calif., USA 1990 and “Farm Chemicals Handbook '90”, Meister Publishing Company, Willoughby Ohio, USA, 1990.

### Safeners

Examples of safeners are, inter alia:

a) Compounds of the formulae (S-II) to (S-IV),

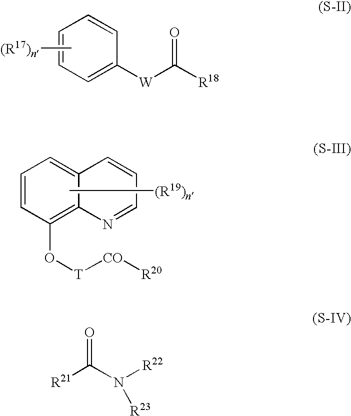

the symbols and indices having the following meanings:
n′ is a natural number from 0 to 5, preferably from 0 to 3;
T is a (C₁ or C₂)-alkanediyl chain which is unsubstituted or substituted by one or two (C₁-C₄)-alkyl radicals or by [(C₁-C₃)-alkoxy]carbonyl;
W is an unsubstituted or substituted divalent heterocyclic radical selected from the group consisting of the partly unsaturated or aromatic heterocycles having five-membered ring and 1 to 3 hetero ring atoms of the type N or O, at least one N atom and not more than one O atom being present in the ring, preferably a radical selected from the group consisting of (W1) to (W4),
R²⁷

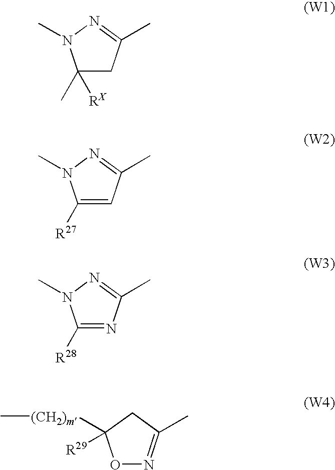

m′ is 0 or 1;
R¹⁷, R¹⁹ are identical or different and are halogen, (C₁-C₄)alkyl, (C₁-C₄)alkoxy, nitro or (C₁-C₄)haloalkyl;
R¹⁸, R²⁰ are identical or different and are OR²⁴, SR²⁴ or NR²⁴R²⁵ or a saturated or unsaturated 3- to 7-membered heterocycle having at least one N atom and up to 3 heteroatoms, preferably selected from the group consisting of O and S, which is linked via the N atom to the carbonyl group in (S-II) or (S-III) and is unsubstituted or substituted by radicals selected from the group consisting of (C₁-C₄)alkyl, (C₁-C₄)alkoxy or optionally substituted phenyl, preferably a radical of the formula OR²⁴, NHR²⁵ or N(CH₃)₂, in particular of the formula OR²⁴;
R²⁴ is hydrogen or an unsubstituted or substituted aliphatic hydrocarbon radical, preferably having altogether 1 to 18 carbon atoms;
R²⁵ is hydrogen, (C₁-C₆)alkyl, (C₁-C₆)alkoxy or substituted or unsubstituted phenyl;
R^{x} is H, (C₁-C₈)alkyl, C₁-C₈(haloalkyl), (C₁-C₄)alkoxy(C₁-C₈)alkyl, cyano or COOR²⁶, in which R²⁶ is hydrogen, (C₁-C₈)alkyl, (C₁-C₈)haloalkyl, (C₁-C₄)alkoxy-(C₁-C₄)alkyl, (C₁-C₆)hydroxyalkyl, (C₃-C₁₂)cycloalkyl or tri(C₁-C₄)alkylsilyl;
R²⁷, R²⁸, R²⁹ are identical or different and are hydrogen, (C₁-C₈)alkyl, (C₁-C₈)haloalkyl, (C₃-C₁₂)cycloalkyl or substituted or unsubstituted phenyl;
R²¹ is (C₁-C₄)alkyl, (C₁-C₄)haloalkyl, (C₂-C₄)alkenyl, (C₂-C₄)haloalkenyl, (C₃-C₇)cycloalkyl, preferably dichloromethyl;
R²², R²³ are identical or different and are hydrogen, (C₁-C₄)alkyl, (C₂-C₄)alkenyl, (C₂-C₄)alkynyl, (C₁-C₄)haloalkyl, (C₂-C₄)haloalkenyl, (C₁-C₄)alkylcarbamoyl(C₁-C₄)alkyl, (C₂-C₄)alkenylcarbamoyl(C₁-C₄)alkyl, (C₁-C₄)alkoxy(C₁-C₄)alkyl, dioxolanyl-(C₁-C₄)alkyl, thiazolyl, furyl, furylalkyl, thienyl, piperidyl, substituted or unsubstituted phenyl, or R²² and R²³ together form a substituted or unsubstituted heterocyclic ring, preferably an oxazolidine, thiazolidine, piperidine, morpholine, hexahydropyrimidine or benzoxazine ring;
   preferably safeners of the following subgroups of compounds of the formulae (S-II) to (S-IV):
   compounds of the type consisting of the dichlorophenylpyrazoline-3-carboxylic acid (i.e. of the formula (S-II), in which W=(W1) and (R¹⁷)_{n′}=2,4-Cl₂), preferably compounds such as ethyl 1-(2,4-dichlorophenyl)-5-(ethoxycarbonyl)-5-methyl-2-pyrazoline-3-carboxylate (II-1, mefenpyr-diethyl), mefenpyr-dimethyl and mefenpyr (II-0), and related compounds, as described in WO-A-91/07874;
   derivatives of dichlorophenylpyrazolecarboxylic acid (i.e. of the formula (S-II), in which W is (W2) and (R¹⁷)_{n′} is 2,4-Cl₂), preferably compounds such as ethyl 1-(2,4-dichlorophenyl)-5-methylpyrazole-3-carboxylate (II-2), ethyl 1-(2,4-dichlorophenyl)-5-isopropylpyrazole-3-carboxylate (II-3), ethyl 1-(2,4-dichlorophenyl)-5-(1,1-di methylethyl)pyrazole-3-carboxylate (II-4), ethyl 1-(2,4-dichlorophenyl)-5-phenylpyrazole-3-carboxylate (II-5) and related compounds as described in EP-A-0333131 and EP-A-0269806;
   compounds of the type consisting of the triazolecarboxylic acids (i.e. of the formula (S-II), in which W is (W3) and (R¹⁷)_{n′} is 2,4-Cl₂), preferably compounds such as fenchlorazol-ethyl, i.e. ethyl 1-(2,4-dichlorophenyl)-5-trichloromethyl-(1H)-1,2,4-triazole-3-carboxylate (II-6), and related compounds (cf. EP-A-0174562 and EP-A-0346620);
   compounds of the type consisting of 5-benzyl- or 5-phenyl-2-isoxazoline-3-carboxylic acid or of 5,5-diphenyl-2-isoxazoline-3-carboxylic acid, such as isoxadifen (II-12), (in which W is (W4)), preferably compounds such as ethyl 5-(2,4-dichlorobenzyl)-2-isoxazoline-3-carboxylate (II-7) or ethyl 5-phenyl-2-isoxazoline-3-carboxylate (II-8) and related compounds as described in WO-A-91/08202, or ethyl 5,5-diphenyl-2-isoxazolinecarboxylate (II-9, isoxadifen-ethyl) or n-propyl 5,5-diphenyl-2-isoxazolinecarboxylate (II-10) or ethyl 5-(4-fluorophenyl)-5-phenyl-2-isoxazoline-3-carboxylate (II-11), as described in WO-A-95/07897.
   compounds of the type consisting of 8-quinolineoxyacetic acid, for example those of the formula (S-III), in which (R¹⁹)_{n′} is 5-Cl, R²⁰ is OR²⁴ and T is CH₂, preferably the compounds 1-methylhexyl(5-chloro-8-quinolinoxy)acetate (III-1, cloquintocet-mexyl), 1,3-dimethylbut-1-yl(5-chloro-8-quinolinoxy)acetate (III-2), 4-allyloxybutyl(5-chloro-8-quinolinoxy)acetate (III-3), 1-allyloxyprop-2-yl(5-chloro-8-quinolinoxy)acetate (III-4), ethyl (5-chloro-8-quinolinoxy)acetate (III-5), methyl (5-chloro-8-quinolinoxy)acetate (III-6), allyl (5-chloro-8-quinolinoxy)acetate (III-7), 2-(2-propylideneiminoxy)-1-ethyl (5-chloro-8-quinolinoxy)acetate (III-8), 2-oxoprop-1-yl (5-chloro-8-quinolinoxy)acetate (111-9), (5-chloro-8-quinolinoxy)acetic acid (III-10) and the salts thereof, as described, for example, in WO-A-02/34048, and related compounds as described in EP-A-0860750, EP-A-0094349 and EP-A-0191736 or EP-A-0492366.
   compounds of the type consisting of (5-chloro-8-quinolinoxy)malonic acid, i.e. of the formula (S-III), in which (R¹⁹)_{n′} is 5-Cl, R²⁰ is OR²⁴ and T is —CH(COO-alkyl)-, preferably the compounds diethyl (5-chloro-8-quinolinoxy)malonate (III-11), diallyl (5-chloro-8-quinolinoxy)malonate, methyl ethyl (5-chloro-8-quinolinoxy)malonate and related compounds as described in EP-A-0582198.
   compounds of the type consisting of the dichloroacetamides, i.e. of the formula (S-IV), preferably: N,N-diallyl-2,2-dichloroacetamide (dichlormid (IV-1), from U.S. Pat. No. 4,137,070), 4-dichloroacetyl-3,4-dihydro-3-methyl-2H-1,4-benzoxazine (IV-2, benoxacor, from EP 0149974), N1,N2-diallyl-N2-dichloroacetylglycinamide (DKA-24 (IV-3), from HU 2143821), 4-dichloroacetyl-1-oxa-4-azaspiro[4,5]decane (AD-67), 2,2-dichloro-N-(1,3-dioxolan-2-ylmethyl)-N-(2-propenyl)acetamide (P PG-1292), 3-dichloroacetyl-2,2,5-trimethyloxazolidine (R-29148, IV-4), 3-dichloroacetyl-2,2-dimethyl-5-phenyloxazolidine, 3-dichloroacetyl-2,2-dimethyl-5-(2-thienyl)oxazolidine, 3-dichloroacetyl-5-(2-furanyl)-2,2-dimethyloxazolidine (furilazole (IV-5), MON 13900), 1-dichloroacetylhexahydro-3,3,8a-trimethylpyrrolo[1,2-a]pyrimidin-6(2H)-one (dicyclonon, BAS 145138),
      b) one or more compounds from the group:
      1,8-naphthalic anhydride, methyl diphenylmethoxyacetate, 1-(2-chlorobenzyl)-3-(1-methyl-1-phenylethyl)urea (cumyluron), O,O-diethyl S-2-ethylthioethyl phosphorodithioate (disulfoton), 4-chlorophenyl methylcarbamate (mephenate), O,O-diethyl-O-phenylphosphorothioate (dietholate), 4-carboxy-3,4-dihydro-2H-1-benzopyran-4-acetic acid (CL-304415, CAS reg. no.: 31541-57-8), cyanomethoxyimino(phenyl)acetonitrile (cyometrinil), 1,3-dioxolan-2-ylmethoxyimino(phenyl)acetonitrile (oxabetrinil), 4′-chloro-2,2,2-trifluoroacetophenone O-1,3-dioxolan-2-ylmethyloxime (fluxofenim), 4,6-dichloro-2-phenylpyrimidine (fenclorim), benzyl-2-chloro-4-trifluoromethyl-1,3-thiazole-5-carboxylate (flurazole), 2-dichloromethyl-2-methyl-1,3-dioxolane (MG-191), N-(4-methylphenyl)-N′-(1-methyl-1-phenylethyl)urea (dymron), (2,4-dichlorophenoxy)acetic acid (2,4-D), (4-chlorophenoxy)acetic acid, (R,S)-2-(4-chloro-o-tolyloxy)propionic acid (mecoprop), 4-(2,4-dichlorophenoxy)butyric acid (2,4-DB), (4-chloro-o-tolyloxy)acetic acid (MCPA), 4-(4-chloro-o-tolyloxy)butyric acid, 4-(4-chlorophenoxy)butyric acid, 3,6-dichloro-2-methoxybenzoic acid (dicamba), 1-(ethoxycarbonyl)ethyl 3,6-dichloro-2-methoxybenzoate (lactidichlor) and the salts and the esters thereof, preferably (C₁-C₈);
      c) N-acylsulfonamides of the formula (S-V) and their salts,

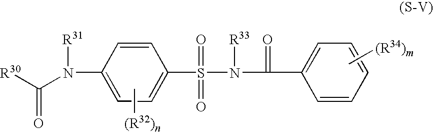

in which
R³⁰ is hydrogen, a hydrocarbon radical, a hydrocarbon-oxy radical, a hydrocarbon-thiol radical or a heterocyclyl radical which is preferably bonded via a carbon atom, each of the last-mentioned 4 radicals being unsubstituted or substituted by one or more identical or different radicals from the group consisting of halogen, cyano, nitro, amino, hydroxyl, carboxyl, formyl, carbonamide, sulfonamide and radicals of the formula —Z^{a}—R^{a},
   each hydrocarbon moiety preferably having 1 to 20 carbon atoms and a carbon-containing radical R³⁰, including substituents, preferably having 1 to 30 carbon atoms;
R³¹ is hydrogen or (C₁-C₄)-alkyl, preferably hydrogen, or
R³⁰ and R³¹, together with the group of the formula —CO—N—, forming the radical of a 3- to 8-membered saturated or unsaturated ring;
R³² are identical or different and are halogen, cyano, nitro, amino, hydroxyl, carboxyl, formyl, CONH₂, SO₂NH₂ or a radical of the formula —Z^{b}—R^{b};
R³³ is hydrogen or (C₁-C₄)-alkyl, preferably H;
R³⁴ are identical or different and are halogen, cyano, nitro, amino, hydroxyl, carboxyl, CHO, CONH₂, SO₂NH₂ or a radical of the formula —Z^{c}—R^{c};
R^{a} is a hydrocarbon radical or a heterocyclyl radical, each of the two last-mentioned radicals being unsubstituted or substituted by one or more identical or different radicals from the group consisting of halogen, cyano, nitro, amino, hydroxyl, mono- and di[(C₁-C₄)-alkyl]amino, or an alkyl radical in which a plurality of non-neighboring CH₂ groups, preferably 2 or 3 non-neighboring CH₂ groups, are replaced in each case by an oxygen atom; and
R^{b}, R^{c} are identical or different and are a hydrocarbon radical or a heterocyclyl radical, each of the two last-mentioned radicals being unsubstituted or substituted by one or more identical or different radicals from the group consisting of halogen, cyano, nitro, amino, hydroxyl, phosphoryl, halo-(C₁-C₄)-alkoxy, mono- and di[(C₁-C₄)-alkyl]amino, or an alkyl radical in which a plurality of non-neighboring CH₂ groups, preferably 2 or 3 non-neighboring CH₂ groups are replaced in each case by an oxygen atom;
Z^{a} is a divalent group of the formula —O—, —S—, —CO—, —CS—, —CO—O—, —CO—S—, —O—CO—, —S—CO—, —SO—, —SO₂—, —NR*—, —CO—NR*—, —NR*—CO—, —SO₂—NR*— or —NR*—SO₂—, the right-hand bond of the respective divalent group being the bond to the radical R^{a}, and R* in the last-mentioned 5 radicals, independently of one another, being in each case H, (C₁-C₄)-alkyl or halo-(C₁-C₄)-alkyl;
Z^{b}, Z^{c} independently of one another, are a direct bond or a divalent group of the formula —O—, —S—, —CO—, —CS—, —CO—O—, —CO—S—, —O—CO—, —S—CO—, —SO—, —SO₂—, —NR*—, —SO₂—NR*—, —NR*—SO₂—, —CO—NR*— or —NR*—CO—, the right-hand bond of the respective divalent group being the bond to the radical R^{b} or R^{c}, and R* in the last-mentioned 5 radicals, independently of one another, being in each case H, (C₁-C₄)-alkyl or halo-(C₁-C₄)-alkyl;
n is an integer from 0 to 4, preferably 0, 1 or 2, in particular 0 or 1, and
m is an integer from 0 to 5, preferably 0, 1, 2 or 3, in particular 0, 1 or 2;
   preferably safeners of compounds of the formula (S-V), in which
   R³⁰ is H₃C—O—CH₂—, R³¹ is R³³ is H, R³⁴ is 2-OMe (V-1),
   R³⁰ is H₃C—O—CH₂—, R³¹ is R³³ is H, R³⁴ is 2-OMe-5-Cl (V-2),
   R³⁰ is cyclopropyl, R³¹ is R³³ is H, R³⁴ is 2-OMe (V-3),
   R³⁰ is cyclopropyl, R³¹ is R³³ is H, R³⁴ is 2-OMe-5-Cl (V-4),
   R³⁰ is cyclopropyl, R³¹ is R³³ is H, R³⁴ is 2-Me (V-5),
   R³⁰ is tert-butyl, R³¹ is R³³ is H, R³⁴ is 2-OMe (V-6).
      d) Acylsulfamoylbenzamides of the formula (S-VI), optionally also in salt form,

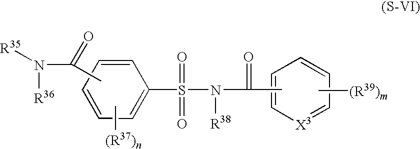

in which
X³ is CH or N;
R³⁵ is hydrogen, heterocyclyl or a hydrocarbon radical, the two last-mentioned radicals optionally being substituted by one or more, identical or different radicals selected from the group consisting of halogen, cyano, nitro, amino, hydroxyl, carboxyl, CHO, CONH₂, SO₂NH₂ and Z^{a}-R^{a};
R³⁶ is hydrogen, hydroxyl, (C₁-C₆)-alkyl, (C₂-C₆)-alkenyl, (C₂-C₆)-alkynyl, (C₁-C₆)-alkoxy, (C₂-C₆)-alkenyloxy, the five last-mentioned radicals optionally being substituted by one or more, identical or different radicals selected from the group consisting of halogen, hydroxyl, (C₁-C₄)-alkyl, (C₁-C₄)-alkoxy and (C₁-C₄)-alkylthio, or
R³⁵ and R³⁶, together with the nitrogen atom carrying them, are a 3-membered to 8-membered saturated or unsaturated ring;
R³⁷ is halogen, cyano, nitro, amino, hydroxyl, carboxyl, CHO, CONH₂, SO₂NH₂ or Z^{b}-R^{b};
R³⁸ is hydrogen, (C₁-C₄)-alkyl, (C₂-C₄)-alkenyl or (C₂-C₄)-alkynyl;
R³⁹ is halogen, cyano, nitro, amino, hydroxyl, carboxyl, phosphoryl, CHO, CONH₂, SO₂NH₂ or Z^{c}—R^{c};
R^{a} is a (C₂-C₂₀)-alkyl radical whose carbon chain is interrupted once or several times by oxygen atoms, a heterocyclyl or a hydrocarbon radical, the two last-mentioned radicals optionally being substituted by one or more, identical or different radicals selected from the group consisting of halogen, cyano, nitro, amino, hydroxyl, mono- and di[(C₁-C₄)-alkyl]amino;
R^{b}, R^{c} are identical or different and are a (C₂-C₂₀)-alkyl radical whose carbon chain is interrupted once or several times by oxygen atoms, heterocyclyl or a hydrocarbon radical, the two last-mentioned radicals optionally being substituted by one or more, identical or different radicals selected from the group consisting of halogen, cyano, nitro, amino, hydroxyl, phosphoryl, (C₁-C₄)-haloalkoxy, mono- and di[(C₁-C₄)-alkyl]amino;
Z^{a} is a divalent unit selected from the group consisting of O, S, CO, CS, C(O)O, C(O)S, SO, SO₂, NR^{d}, C(O)NR^{d} or SO₂NR^{d};
Z^{b}, Z^{c} are identical or different and are a direct bond or a divalent unit selected from the group consisting of O, S, CO, CS, C(O)O, C(O)S, SO, SO₂, NR^{d}, SO₂NR^{d} or C(O)NR^{d};
R^{d} is hydrogen, (C₁-C₄)-alkyl or (C₁-C₄)-haloalkyl;
n is an integer from 0 to 4, and
m is an integer from 0 to 5 where X is CH and is an integer from 0 to 4 where X is N;
   preferably safeners of compounds of the formula (S-VI), in which
X³ is CH;
R³⁵ is hydrogen, (C₁-C₆)-alkyl, (C₃-C₆)-cycloalkyl, (C₂-C₆)-alkenyl, (C₅-C₆)-cycloalkenyl, phenyl or 3- to 6-membered heterocyclyl having up to three heteroatoms selected from the group consisting of nitrogen, oxygen and sulfur, the six last-mentioned radicals optionally being substituted by one or more, identical or different substituents selected from the group consisting of halogen, (C₁-C₆)-alkoxy, (C₁-C₆)-haloalkoxy, (C₁-C₂)-alkylsulfinyl, (C₁-C₂)-alkylsulfonyl, (C₃-C₆)-cycloalkyl, (C₁-C₄)-alkoxycarbonyl, (C₁-C₄)-alkylcarbonyl and phenyl and, in the case of cyclic radicals, also (C₁-C₄)-alkyl and (C₁-C₄)-haloalkyl;
R³⁶ is hydrogen, (C₁-C₆)-alkyl, (C₂-C₆)-alkenyl, (C₂-C₆)-alkynyl, the three last-mentioned radicals optionally being substituted by one or more, identical or different substituents selected from the group consisting of halogen, hydroxyl, (C₁-C₄)-alkyl, (C₁-C₄)-alkoxy and (C₁-C₄)-alkylthio;
R³⁷ is halogen, (C₁-C₄)-haloalkyl, (C₁-C₄)-haloalkoxy, nitro, (C₁-C₄)-alkyl, (C₁-C₄)-alkoxy, (C₁-C₄)-alkylsulfonyl, (C₁-C₄)-alkoxycarbonyl or (C₁-C₄)-alkylcarbonyl;
R³⁸ is hydrogen;
R³⁹ is halogen, nitro, (C₁-C₄)-alkyl, (C₁-C₄)-haloalkyl, (C₁-C₄)-haloalkoxy, (C₃-C₆)-cycloalkyl, phenyl, (C₁-C₄)-alkoxy, cyano, (C₁-C₄)-alkylthio, (C₁-C₄)-alkylsulfinyl, (C₁-C₄)-alkylsulfonyl, (C₁-C₄)-alkoxycarbonyl or (C₁-C₄)-alkylcarbonyl;
n is 0, 1 or 2 and
m is 1 or 2.

In particular, compounds of the type consisting of the acylsulfamoylbenzamides of the following formula (S-VII), which are disclosed, for example, in WO-A-99/16744,

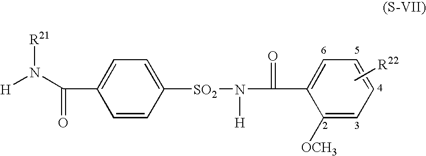

in which
R²¹ is cyclopropyl and R²² is H(S3-1=4-cyclopropylaminocarbonyl-N-(2-methoxybenzoyl)benzenesulfonamide; cyprosulfamide);
R²¹ is cyclopropyl and R²² is 5-Cl (S3-2),
R²¹ is ethyl and R²² is H(S3-3),
R²¹ is isopropyl and R²² is 5-Cl (S3-4) and
R²¹ is isopropyl and R²² is H(S3-5=4-isopropylaminocarbonyl-N-(2-methoxybenzoyl)benzenesulfonamide);
   e) compounds of the type consisting of the N-acylsulfamoylphenylureas of the formula (S-VIII), which is disclosed, for example, in EP-A-365484,

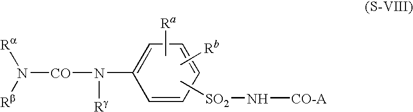

in which
A is a radical selected from the group consisting of

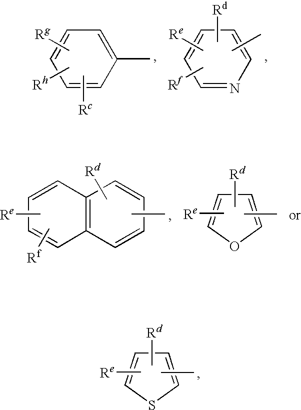

R^{α} and R^{β}, independently of one another, are hydrogen, C₁-C₈-alkyl, C₃-C₈-cycloalkyl, C₃-C₆-alkenyl, C₃-C₆-alkynyl,

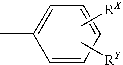

or C₁-C₄-alkoxy substituted by C₁-C₄-alkoxy or by

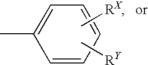

R^{α} and R^{β} together are a C₄-C₆-alkylene bridge or a C₄-C₆-alkylene bridge interrupted by oxygen, sulfur, SO, SO₂, NH or —N(C₁-C₄-alkyl)-,
R^{γ} is hydrogen or C₁-C₄-alkyl,
R^{a} and R^{b}, independently of one another, are hydrogen, halogen, cyano, nitro, trifluoromethyl, C₁-C₄-alkyl, C₁-C₄-alkoxy, C₁-C₄-alkylthio, C₁-C₄-alkylsulfinyl, C₁-C₄-alkylsulfonyl, —COOR^{j}, —CONR^{k}R^{m}, —CORⁿ, —SO₂NR^{k}R^{m} or —OSO₂—C₁-C₄-alkyl, or R^{a} and R^{b} together are a C₃-C₄-alkylene bridge which may be substituted by halogen or C₁-C₄-alkyl, or a C₃-C₄-alkenylene bridge which may be substituted by halogen or C₁-C₄-alkyl, or a C₄-alkadienylene bridge which may be substituted by halogen or C₁-C₄-alkyl,
R^{g} and R^{h}, independently of one another, are hydrogen, halogen, C₁-C₄-alkyl, trifluoromethyl, methoxy, methylthio or —COOR^{j},
R^{c} being hydrogen, halogen, C₁-C₄-alkyl or methoxy,
R^{d} is hydrogen, halogen, nitro, C₁-C₄-alkyl, C₁-C₄-alkoxy, C₁-C₄-alkylthio, C₁-C₄-alkylsulfinyl, C₁-C₄-alkylsulfonyl, —COOR^{j} or —CONR^{k}R^{m},
R^{e} being hydrogen, halogen, C₁-C₄-alkyl, —COOR^{j}, trifluoromethyl or methoxy, or R^{d} and R^{e} together being a C₃-C₄-alkylene bridge,
R^{f} being hydrogen, halogen or C₁-C₄-alkyl,
R^{X} and R^{Y}, independently of one another, are hydrogen, halogen, C₁-C₄-alkyl, C₁-C₄-alkoxy, C₁-C₄-alkylthio, —COOR⁴, trifluoromethyl, nitro or cyano,
R^{j}, R^{k} and R^{m}, independently of one another, are hydrogen or C₁-C₄-alkyl,
R^{k} and R^{m} together are a C₄-C₆-alkylene bridge or a C₄-C₆-alkylene bridge interrupted by oxygen, NH or —N(C₁-C₄-alkyl)-, and
Rⁿ is C₁-C₄-alkyl, phenyl or phenyl substituted by halogen, C₁-C₄-alkyl, methoxy, nitro or trifluoromethyl;
   preferably safeners of the formula (S-VIII) are
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea,
1-[4-(N-naphthoylsulfamoyl)phenyl]-3,3-dimethylurea,
   including the stereoisomers and the salts customary in agriculture.

Unless defined otherwise specifically, in general the following definitions apply to the radicals in the formulae (S-II) to (S-VIII).

The radicals alkyl, alkoxy, haloalkyl, haloalkoxy, alkylamino and alkylthio and the corresponding unsaturated and/or substituted radicals may be in each case straight-chain or branched in the carbon skeleton.

Alkyl radicals, also in the combination meanings, such as alkoxy, haloalkyl, etc., preferably have 1 to 4 carbon atoms and are, for example, methyl, ethyl, n-propyl or isopropyl, n-butyl, isobutyl, tert-butyl or 2-butyl. Alkenyl and alkynyl radicals have the meaning of the possible unsaturated radicals corresponding to the alkyl radicals; alkenyl is, for example, allyl, 1-methylprop-2-en-1-yl, 2-methylprop-2-en-1-yl, but-2-en-1-yl, but-3-en-1-yl, 1-methylbut-3-en-1-yl and 1-methylbut-2-en-1-yl. Alkynyl is, for example, propargyl, but-2-yn-1-yl, but-3-yn-1-yl, 1-methylbut-3-yn-1-yl. “(C₁-C₄)-alkyl” is the abbreviated notation for alkyl having 1 to 4 carbon atoms; the same applies to other general definitions of radicals having ranges stated in brackets for the possible number of carbon atoms.

Cycloalkyl is preferably a cyclic alkyl radical having 3 to 8, preferably 3 to 7, particularly preferably 3 to 6, carbon atoms, for example cyclopropyl, cyclobutyl, cyclopentyl and cyclohexyl. Cycloalkenyl and cycloalkynyl are corresponding unsaturated compounds.

Halogen is fluorine, chlorine, bromine or iodine. Haloalkyl, haloalkenyl and haloalkynyl are alkyl, alkenyl or alkynyl partly or completely substituted by halogen, preferably by fluorine, chlorine and/or bromine, in particular by fluorine or chlorine, e.g. CF₃, CHF₂, CH₂F, CF₂CF₃, CH₂CHFCl, CCl₃, CHCl₂, CH₂CH₂Cl. Haloalkoxy is, for example, OCF₃, OCHF₂, OCH₂F, OCF₂CF₃, OCH₂CF₃ and OCH₂CH₂Cl. The same applies to other halogen-substituted radicals.

A hydrocarbon radical may be an aromatic or an aliphatic hydrocarbon radical, an aliphatic hydrocarbon radical generally being a straight-chain or branched saturated or unsaturated hydrocarbon radical, preferably having 1 to 18, particular preferably 1 to 12, carbon atoms, e.g. alkyl, alkenyl or alkynyl.

Preferably, an aliphatic hydrocarbon radical is alkyl, alkenyl or alkynyl having up to 12 carbon atoms; the same applies to an aliphatic hydrocarbon radical in a hydrocarbon-oxy radical.

Aryl is generally a mono-, bi- or polycyclic aromatic system having preferably 6-20 carbon atoms, preferably 6 to 14 carbon atoms, particularly preferably 6 to 10 carbon atoms, e.g. phenyl, naphthyl, tetrahydronaphthyl, indenyl, indanyl, pentalenyl and fluorenyl, particularly preferably phenyl.

Heterocyclic ring, heterocyclic radical or heterocyclyl is a mono-, bi- or polycyclic ring system which is saturated, unsaturated and/or aromatic and contains one or more, preferably 1 to 4, heteroatoms, preferably selected from the group consisting of N, S and O.

Saturated heterocycles having 3 to 7 ring atoms and one or two heteroatoms selected from the group consisting of N, O and S are preferred, the chalcogens being non-neighboring. Monocyclic rings having 3 to 7 ring atoms and a heteroatom selected from the group consisting of N, O and S, and morpholine, dioxolane, piperazine, imidazoline and oxazolidine, are particularly preferred. Very particularly preferred saturated heterocycles are oxirane, pyrrolidone, morpholine and tetrahydrofuran.

Partly unsaturated heterocycles having 5 to 7 ring atoms and one or two heteroatoms selected from the group consisting of N, O and S are also preferred. Partly unsaturated heterocycles having 5 or 6 ring atoms and a heteroatom selected from the group consisting of N, O and S are particularly preferred. Very particularly preferred partly unsaturated heterocycles are pyrazoline, imidazoline and isoxazoline.

Heteroaryl, e.g. mono- or bicyclic aromatic heterocycles having 5 or 6 ring atoms which contain one to four heteroatoms selected from the group consisting of N, O, S, is also preferred, the chalcogens being non-neighboring. Monocyclic aromatic heterocycles having 5 or 6 ring atoms which contain a heteroatom selected from the group consisting of N, O and S, and pyrimidine, pyrazine, pyridazine, oxazole, thiazole, thiadiazole, oxadiazole, pyrazole, triazole and isoxazole, are particularly preferred. Pyrazole, thiazole, triazole and furan are very particularly preferred.

Substituted radicals, such as substituted hydrocarbon radicals, e.g. substituted alkyl, alkenyl, alkynyl, aryl, such as phenyl, and arylalkyl, such as benzyl, or substituted heterocyclyl are a substituted radical derived from the unsubstituted parent body, the substituents preferably being one or more, preferably 1, 2 or 3, substituents, in the case of Cl and F even up to the maximum possible number of substituents, selected from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl and haloalkyl, and unsaturated aliphatic substituents corresponding to said saturated hydrocarbon-containing substituents, preferably alkenyl, alkynyl, alkenyloxy, alkynyloxy. In the case of radicals having carbon atoms, those having 1 to 4 carbon atoms, in particular 1 or 2 carbon atoms, are preferred. As a rule, substituents selected from the group consisting of halogen, e.g. fluorine or chlorine, (C₁-C₄)alkyl, preferably methyl or ethyl, (C₁-C₄)haloalkyl, preferably trifluoromethyl, (C₁-C₄)alkoxy, preferably methoxy or ethoxy, (C₁-C₄)haloalkoxy, nitro and cyano are preferred. The substituents methyl, methoxy and chlorine are particularly preferred.

Mono- or disubstituted amino is a chemically stable radical selected from the group consisting of the substituted amino radicals which are N-substituted, for example, by one or two identical or different radicals selected from the group consisting of alkyl, alkoxy, acyl and aryl; preferably monoalkylamino, dialkylamino, acylamino, arylamino, N-alkyl-N-arylamino and N-heterocycles. Alkyl radicals having 1 to 4 carbon atoms are preferred. Aryl is preferably phenyl. Substituted aryl is preferably substituted phenyl. The definition mentioned further below, preferably (C₁-C₄)alkanoyl, is applicable for acyl. The same applies to substituted hydroxylamino or hydrazino.

Optionally substituted phenyl is preferably phenyl which is unsubstituted or mono- or polysubstituted, preferably up to trisubstituted, in the case of halogen, such as Cl or F, also up to pentasubstituted, by identical or different radicals selected from the group consisting of halogen, (C₁-C₄)alkyl, (C₁-C₄)alkoxy, (C₁-C₄)haloalkyl, (C₁-C₄)haloalkoxy and nitro, e.g. o-, m- and p-tolyl, dimethylphenyls, 2-, 3- and 4-chlorophenyl, 2-, 3- and 4-trifluoro- and trichlorophenyl, 2,4-, 3,5-, 2,5- and 2,3-dichlorophenyl, o-, m- and p-methoxyphenyl.

An acyl radical is the radical of an organic acid having preferably up to 6 carbon atoms, for example the radical of a carboxylic acid and radicals of acids derived therefrom, such as thiocarboxylic acid, optionally N-substituted iminocarboxylic acids, or the radical of carbonic acid monoesters, optionally N-substituted carbamic acids, sulfonic acids, sulfinic acids, phosphonic acids, phosphinic acids. Acyl is, for example, formyl, alkylcarbonyl, such as (C₁-C₄-alkyl)carbonyl, phenylcarbonyl, it being possible for the phenyl ring to be substituted, for example as stated above for phenyl, or alkyloxycarbonyl, phenyloxycarbonyl, benzyloxycarbonyl, alkylsulfonyl, alkylsulfinyl or N-alkyl-1-iminoalkyl.

The formulae (S-II) to (S-VIII) also comprise all stereoisomers which have the same topological linkage of the atoms, and mixtures thereof. Such compounds contain one or more asymmetric carbon atoms or even double bonds, which are not specially shown in the general formulae. Possible stereoisomers defined by their specific spatial form, such as enantiomers, diastereomers, Z- and E-isomers, can be obtained by customary methods from mixtures of the stereoisomers or can be prepared by stereoselective reactions in combination with the use of stereochemically pure starting materials.

The compounds of the formula (S-II) are disclosed, for example, in EP-A-0333131 (ZA-89/1960), EP-A-0269806 (U.S. Pat. No. 4,891,057), EP-A-0346620 (AU-A-89/34951), EP-A-0174562, EP-A-0346620 (WO-A-91/08202), WO-A-91/07874 or WO-A-95/07897 (ZA 94/7120) and the literature cited there or can be prepared by or analogously to the processes described there. The compounds of the formula (S-III) are disclosed in EP-A-0086750, EP-A-094349 (U.S. Pat. No. 4,902,340), EP-A-0191736 (U.S. Pat. No. 4,881,966) and EP-A-0492366 and literature cited there or can be prepared by or analogously to the processes described there. Some compounds are furthermore described in EP-A-0582198 and WO-A-02/34048. The compounds of the formula (S-IV) are disclosed in numerous patent applications, for example U.S. Pat. No. 4,021,224 and U.S. Pat. No. 4,021,229. Compounds of subgroup b) are furthermore disclosed in CN-A-87/102789, EP-A-365484 and in “The Pesticide Manual”, 11th to 13th edition, British Crop Protection Council and The Royal Society of Chemistry (1997). The compounds of subgroup c) are disclosed in WO-A-97/45016, those of subgroup d) in WO-A-99/16744 (in particular in EP-A-365484). The documents cited contain detailed information about preparation processes and starting materials and mention preferred compounds. Reference is made expressly to these publications and they are considered to be part of this description through citation.

The safeners of the above groups a) to e) reduce or suppress phytotoxic effects which may occur with the use of the herbicides according to the invention in crops of useful plants without impairing the efficiency of the herbicides against harmful plants. As a result of this, the field of use of the herbicides can be considerably extended and in particular the use of herbicides which could be used to date only to a limited extent or with insufficient success, i.e. of combinations which, without safener, in low doses with a poor activity spectrum, led to insufficient control of the harmful plants, is by the use of safeners.

Inter alia, particularly preferred safeners in the formulations according to the invention are: 4-dichloroacetyl-1-oxa-4-azaspiro[4.5]decane (AD-67), 1-dichloroacetylhexahydro-3,3,8a-trimethylpyrrolo[1,2-a]pyrimidin-6(2H)-one (dicyclonon, BAS-145138), 4-dichloroacetyl-3,4-dihydro-3-methyl-2H-1,4-benzoxazine (benoxacor), cloquintocet, 1-methylhexyl 5-chloroquinolin-8-oxyacetate (cloquintocet-mexyl), α-(cyanomethoxyimino)phenylacetonitrile (cyometrinil), 2,2-dichloro-N-(2-oxo-2-(2-propenylamino)ethyl)-N-(2-propenyl)acetamide (DKA-24), 2,2-dichloro-N,N-di-2-propenylacetamide (dichlormid), N-(4-methylphenyl)-N′-(1-methyl-1-phenylethyl)urea (dymron), 4,6-dichloro-2-phenylpyrimidine (fenclorim), ethyl 1-(2,4-dichlorophenyl)-5-trichloromethyl-1H-1,2,4-triazole-3-carboxylate (fenchlorazol-ethyl), phenylmethyl 2-chloro-4-trifluoromethylthiazole-5-carboxylate (flurazole), 4-chloro-N-(1,3-dioxolan-2-ylmethoxy)-α-trifluoroacetophenone oxime (fluxofenim), 3-dichloroacetyl-5-(2-furanyl)-2,2-dimethyloxazolidine (furilazole, MON-13900), ethyl-4,5-dihydro-5,5-diphenyl-3-isoxazolecarboxylate (isoxadifen-ethyl), diethyl 1-(2,4-dichlorophenyl)-4,5-dihydro-5-methyl-1H-pyrazole-3,5-dicarboxylate (mefenpyr-diethyl), 2-dichloromethyl-2-methyl-1,3-dioxolane (MG-191), 1,8-naphthalic anhydride, α-(1,3-dioxolan-2-ylmethoximino)phenylacetonitrile (oxabetrinil), 2,2-dichloro-N-(1,3-dioxolan-2-ylmethyl)-N-(2-propenyl)acetamide (PPG-1292), 3-dichloroacetyl-2,2-dimethyloxazolidine (R-28725), 3-dichloroacetyl-2,2,5-trimethyloxazolidine (R-29148), methyl 1-(2-chlorophenyl)-5-phenyl-1H-pyrazole-3-carboxylate, 4-cyclopropylaminocarbonyl-N-(2-methoxybenzoyl)benzene-sulfonamide (cyprosulfamide), 4-isopropylaminocarbonyl-N-(2-methoxybenzoyl)benzenesulfonamide and N-(2-methoxybenzoyl)-4-[(methylaminocarbonyl)amino]benzenesulfonamide.

Very particularly preferred are the safeners mefenpyr-diethyl, cloquintocet-mexyl, isoxadifen-ethyl, 4-cyclopropylaminocarbonyl-N-(2-methoxybenzoyl)benzenesulfonamide (cyprosulfamide), 4-isopropylaminocarbonyl-N-(2-methoxybenzoyl)benzenesulfonamide or fenchlorazol-ethyl; in particular, mefenpyr-diethyl, cloquintocet-mexyl or isoxadifen-ethyl are very particularly preferred.

Particular embodiments of the invention are the method for enhancing penetration and the use thereof, TBEP in the amounts according to the invention (B) being applied either simultaneously or sequentially with mixtures of herbicides and safeners (A).

Preferred herbicide-safener mixtures are combinations of the following compounds with one another:

a) compounds which are effective as ACCase inhibitors, such as alloxydim, butroxydim, clethodim, clodinafop-propargyl, cycloxydim, cyhalofop-butyl, diclofop-methyl, fenoxaprop, fenoxaprop-ethyl, fenoxaprop-P, fenoxaprop-P-ethyl, fluazifop, fluazifop-P-butyl, fluazifop-butyl, haloxyfop, haloxyfop-P, haloxyfop-etotyl, haloxyfop-P-methyl, metamifop, profoxydim, propaquizafop, quizalofop-P-tefuryl, quizalofop-P-ethyl, sethoxydim, tepraloxydim, tralkoxydim and isoxapyrifop,
b) compounds which are effective as p-hydroxyphenyl pyruvate dioxygenase (HPPD) inhibitors, such as benzobicyclon, benzofenap, isoxaflutole and its diketonitriles, mesotrione, pyrazolynate, pyrazoxyfen, sulcotrione and isoxachlortole,
c) compounds from different groups of the active substances, such as atrazin, acetochlor, aclonifen, alachlor, amidochlor, amidosulfuron, azimsulfuron, bentazon, bensulfuron(-methyl), bromoxynil(-octanoate/-heptanoate), butachlor, bispyribac, chlorsulfuron, chlorimuron, clomazone, clopyralid, cinosulfuron, cyclosulfamuron, 2,4-D-ester, 2,4-DB-ester, 2,4-DP-ester, CMPP-ester, MCPA-ester, MCPB, EPTC, desmedipham, diflufenican, dicamba, ethoxysulfuron, ethofumesat, flazasulfuron, florasulam, flucarbazone, flumetsulam, flufenacet, fluoroglykofen, fluoroxypyr, flupyrsulfuron, foramsulfuron, flumioxazin, flumiclorac, fomesafen, glufosinate, glyphosate, imazapyr, imazosulfuron, iodosulfuron, iodosulfuron-methyl, ioxynil(-octanoate), lactofen, halosulfuron, imazamox, imazapic, imazapyr, imazethapyr, imazaquin, metosulam, mesosulfuron(-methyl), (S-)metolachlor, metsulfuron-methyl, metamitron, nicosulfuron, oxyfluorfen, pendimethalin, phenmedipham, picloram, pinoxaden, primisulfuron-methyl, prosulfuron, propanil, propoxycarbazone, pyrazosulfuron(-methyl), rimsulfuron, sulfentrazone, sulfosulfuron, sulfometuron, terbuthylazin, thifensulfuron, triasulfuron, tribenuron, triclopyr, triflusulfuron-methyl, trifluralin, tritosulfuron, topramezone, oxazinon, oxadiargyl, metribuzin, and salts thereof, e.g. the sodium salts.
d) compounds which are effective as safeners, such as AD 67 (4-(dichloroacetyl)-1-oxa-4-azaspiro[4.5]decane), benoxacor, CL 304,415 (4-carboxymethylchroman-4-carboxylic acid), cloquintocet, cloquintocet-mexyl, cyprosulfamide, dichlormid, dicyclonon, DKA-24 (N1,N2-diallyl-N2-dichloroacetylglycinamide), fenchlorazole, fenchlorazole-ethyl, fenclorim, flurazole, fluxofenim, furilazole, isoxadifen-ethyl, mefenpyr-diethyl, MG 191 (2-dichloromethyl-2-methyl-1,3-dioxolane), naphthalic anhydride (naphthalene-1,8-dicarboxylic anhydride), oxabetrinil and TI-35 (1-dichloroacetylazepane).

In a further embodiment, for example, different herbicides can be combined with one another, e.g. fenoxaprop-p-ethyl+ioxynil octanoate, diclofop-methyl+bromoxynil octanoate, CMPP+bromoxynil octanoate, MCPA+ioxynil octanoate, bromoxynil octanoate+bromoxynil heptanoate, bromoxynil octanoate+bromoxynil heptanoate+MCPA, bromoxynil octanoate+bromoxynil heptanoate+2,4-D, phenmedipham+desmedipham, phenmedipham+desmedipham+ethofumesate, metamitron+ethofumesate, phenmedipham+ethofumesate+metamitron, fenoxaprop-p-ethyl+iodosulfuron-methyl-sodium, fenoxaprop-p-ethyl+diclofop-methyl, fenoxaprop-p-ethyl+iodosulfuron-methyl-sodium+diclofop-methyl.

Particularly preferred combinations are the following: foramsulfuron+iodosulfuron-methyl-sodium+isoxadifen-ethyl, iodosulfuron-methyl-sodium+isoxadifen-ethyl, foramsulfuron+isoxadifen-ethyl, fenoxaprop-P-ethyl+ethoxysulfuron+isoxadifen-ethyl, ethoxysulfuron+isoxadifen-ethyl, fenoxaprop-P-ethyl+isoxadifen-ethyl, iodosulfuron-methyl-sodium+mesosulfuron-methyl+mefenpyr-diethyl, mesosulfuron-methyl+mefenpyr-diethyl, iodosulfuron-methyl-sodium+mefenpyr-diethyl, fenoxaprop-P-ethyl+mefenpyr-diethyl, fenoxaprop-P-ethyl+diclofop-methyl+mefenpyr-diethyl, diclofop-methyl+mefenpyr-diethyl, diclofop-methyl+sethoxydim+mefenpyr-diethyl, sethoxydim+mefenpyr-diethyl, fenoxaprop-P-ethyl+isoproturon+mefenpyr-diethyl, isoproturon+mefenpyr-diethyl, clodinafop-propargyl+cloquintocet-mexyl, fenoxaprop-ethyl+fenchlorazole-ethyl, fenoxaprop-P-ethyl+fenchlorazole-ethyl, flucarbazone+cyprosulfamide, foramsulfuron+cyprosulfamide, iodosulfuron(-methyl)+cyprosulfamide, metosulam+cyprosulfamide, metsulfuron(-methyl)+cyprosulfamide, nicosulfuron+cyprosulfamide, primisulfuron(.methyl)+cyprosulfamide, prosulfuron+cyprosulfamide, thifensulfuron+cyprosulfamide, tribenuron+cyprosulfamide, cloransulam-methyl+cyprosulfamide, chlorimuron+cyprosulfamide, ethoxysulfuron+cyprosulfamide, flazasulfuron+cyprosulfamide, florasulam+cyprosulfamide, flumetsulam+cyprosulfamide, halosulfuron+cyprosulfamide, imazamox+cyprosulfamide, imazapic+cyprosulfamide, imazapyr+cyprosulfamide, imazethapyr+cyprosulfamide, mesosulfuron+cyprosulfamide, propoxycarbazone+cyprosulfamide, sulfosulfuron+cyprosulfamide, amidosulfuron+cyprosulfamide, chlorsulfuron+cyprosulfamide, imazaquin+cyprosulfamide, triasulfuron+cyprosulfamide, sulfometuron+cyprosulfamide, cyclosulfamuron+cyprosulfamide, flupyrsulfuron+cyprosulfamide, pyrazosulfuron+cyprosulfamide, azimsulfuron+cyprosulfamide, bensulfuron+cyprosulfamide, bispyribac+cyprosulfamide, rimsulfuron+cyprosulfamide, tritosulfuron+cyprosulfamide, sulcotrione+cyprosulfamide, clomazone+cyprosulfamide, mesotrione+cyprosulfamide, topramezone+cyprosulfamide, metribuzin+cyprosulfamide, bentazon+cyprosulfamide, bromoxynil+cyprosulfamide, propanil+cyprosulfamide, atrazin+cyprosulfamide, terbuthylazin+cyprosulfamide, EPTC+cyprosulfamide, tepraloxydim+cyprosulfamide, clethodim+cyprosulfamide, alloyxdim+cyprosulfamide, sethoxydim+cyprosulfamide, tralkoxydim+cyprosulfamide, clodinafop-propargyl+cyprosulfamide, cyhalofop-butyl+cyprosulfamide, diclofop-methyl+cyprosulfamide, fenoxaprop-P-ethyl+cyprosulfamide, fluazifop-P-butyl+cyprosulfamide, haloxyfop-methyl+cyprosulfamide, haloxyfop-etotyl+cyprosulfamide, haloxyfop-R-methyl+cyprosulfamide, haloxyfop-ethoxyethyl+cyprosulfamide, propaquizafop+cyprosulfamide, quizalofop-P-tefuryl+cyprosulfamide, quizalofop-P-ethyl+cyprosulfamide, acetochlor+cyprosulfamide, S-metolachlor+cyprosulfamide, flumioxazin+cyprosulfamide, flumiclorac+cyprosulfamide, fomesafen+cyprosulfamide, sulfentrazone+cyprosulfamide, dicamba+cyprosulfamide, MCPA+cyprosulfamide, MCPB+cyprosulfamide, 2,4-D+cyprosulfamide, clopyralid+cyprosulfamide, fluoroxypyr+cyprosulfamide, picloram+cyprosulfamide, triclopyr+cyprosulfamide, glufosinate+cyprosulfamide, glyphosate+cyprosulfamide and pendimethalin+cyprosulfamide.

The safener:herbicide weight ratio may vary within wide limits and is preferably in the range from 1:100 to 100:1, in particular from 1:100 to 50:1, very particularly preferably from 1:10 to 10:1. The respective optimum amounts of herbicide(s) and safener(s) are usually dependent on the type of herbicide and/or of safener used and on the type of plant stand to be treated.

The crop protection agents according to the invention very particularly preferably include herbicides selected from the group consisting of the ACCase inhibitors, such as alloxydim, butroxydim, clethodim, clodinafop-propargyl, cycloxydim, cyhalofop-butyl, diclofop-methyl, fenoxaprop, fenoxaprop-ethyl, fenoxaprop-P, fenoxaprop-P-ethyl, fluazifop, fluazifop-P-butyl, fluazifop-butyl, haloxyfop, haloxyfop-P, haloxyfop-etotyl, haloxyfop-P-methyl, metamifop, profoxydim, propaquizafop, quizalofop-P-tefuryl, quizalofop-P-ethyl, sethoxydim, tepraloxydim, tralkoxydim and isoxapyrifop; selected from the group consisting of p-hydroxyphenyl pyruvate dioxygenase (HPPD) inhibitors, such as benzobicyclon, benzofenap, isoxaflutole and its diketonitriles, mesotrione, pyrazolynate, pyrazoxyfen, sulcotrione and isoxachlortole; selected from the group consisting of the ALS inhibitors, hydroxybenzonitriles and further different groups of active substances, such as atrazin, acetochlor, aclonifen, alachlor, amidochlor, amidosulfuron, azimsulfuron, bentazon, bensulfuron(-methyl), bromoxynil(-octanoate/-heptanoate), butachlor, bispyribac, chlorsulfuron, chlorimuron, clomazone, clopyralid, cinosulfuron, cyclosulfamuron, 2,4-D-ester, 2,4-DB-ester, 2,4-DP-ester, CMPP-ester, MCPA-ester, MCPB, EPTC, desmedipham, diflufenican, dicamba, ethoxysulfuron, ethofumesat, flazasulfuron, florasulam, flucarbazone, flumetsulam, flufenacet, fluoroglykofen, fluoroxypyr, flupyrsulfuron, foramsulfuron, flumioxazin, flumiclorac, fomesafen, glufosinate, glyphosate, imazapyr, imazosulfuron, iodosulfuron, iodosulfuron-methyl, ioxynil(-octanoate), lactofen, halosulfuron, imazamox, imazapic, imazapyr, imazethapyr, imazaquin, metosulam, mesosulfuron(-methyl), (S-)metolachlor, metsulfuron-methyl, metamitron, nicosulfuron, oxyfluorfen, pendimethalin, phenmedipham, picloram, pinoxaden, primisulfuron-methyl, prosulfuron, propanil, propoxycarbazone, pyrazosulfuron(-methyl), rimsulfuron, sulfentrazone, sulfosulfuron, sulfometuron, terbuthylazin, thifensulfuron, triasulfuron, tribenuron, triclopyr, triflusulfuron-methyl, trifluralin, tritosulfuron, topramezone, oxazinon, oxadiargyl, metribuzin, and salts thereof, for example the sodium salts; selected from the group consisting of the plant growth regulators, such as ethephon, cyclanilide and thidiazuron; selected from the group consisting of the safeners, such as AD 67 (4-(dichloroacetyl)-1-oxa-4-azaspiro[4.5]decane), benoxacor, CL 304,415 (4-carboxymethylchroman-4-carboxylic acid), cloquintocet, cloquintocet-mexyl, cyprosulfamide, dichlormid, dicyclonon, DKA-24 (N1,N2-diallyl-N2-dichloroacetylglycinamide), fenchlorazole, fenchlorazole-ethyl, fenclorim, flurazole, fluxofenim, furilazole, isoxadifen-ethyl, mefenpyr-diethyl, MG 191 (2-dichloromethyl-2-methyl-1,3-dioxolane), naphthalic anhydride (naphthalene-1,8-dicarboxylic anhydride), oxabetrinil and TI-35 (1-dichloroacetylazepane); and mixtures of herbicides and safeners, such as isoxadifen-ethyl mixtures with foramsulfuron, iodosulfuron-methyl-sodium, fenoxaprop-P-ethyl, ethoxysulfuron, such as mefenpyr-diethyl mixtures with iodosulfuron-methyl-sodium, mesosulfuron-methyl, fenoxaprop-P-ethyl, diclofop-methyl, sethoxydim, isoproturon, such as clodinafop-propargyl+cloquintocet-mexyl, such as fenoxaprop-P-ethyl+fenchlorazole-ethyl, such as cyprosulfamide mixtures with flucarbazone, foramsulfuron, iodosulfuron(-methyl), metosulam, metsulfuron(-methyl), nicosulfuron, primisulfuron(-methyl), prosulfuron, thifensulfuron, tribenuron, cloransulam-methyl, chlorimuron, ethoxysulfuron, flazasulfuron, florasulam, flumetsulam, halosulfuron, imazamox, imazapic, imazapyr, imazethapyr, mesosulfuron, propoxycarbazone, sulfosulfuron, amidosulfuron, chlorsulfuron, imazaquin, triasulfuron, sulfometuron, cyclosulfamuron, flupyrsulfuron, pyrazosulfuron, azimsulfuron, bensulfuron, bispyribac, rimsulfuron, tritosulfuron, sulcotrione, clomazone, mesotrione, topramezone, metribuzin, bentazon, bromoxynil, propanil, atrazin, terbuthylazin, EPTC, tepraloxydim, clethodim, alloyxdim, sethoxydim, tralkoxydim, clodinafop-propargyl, cyhalofop-butyl, diclofop-methyl, fenoxaprop-P-ethyl, fluazifop-P-butyl, haloxyfop-methyl, haloxyfop-etotyl, haloxyfop-R-methyl, haloxyfop-ethoxyethyl, propaquizafop, quizalofop-P-tefuryl, quizalofop-P-ethyl, acetochlor, S-metolachlor, flumioxazin, flumiclorac, fomesafen, sulfentrazone, dicamba, MCPA, MCPB, 2,4-D, clopyralid, fluoroxypyr, picloram, triclopyr, glufosinate, glyphosate, pendimethalin.

The crop protection agents used in the method according to the invention contain as a rule from 0.01 to 99% by weight, in particular from 0.1 to 95% by weight, of the active substances selected from the group consisting of the herbicides and/or safeners. The application rates per unit area of the component (A) are in general between 10 and 2000 g AS/ha (AS=active substance, i.e. application rate based on the active substance), preferably between 50 and 300 g AS/ha.

Tributoxyethyl phosphate (TBEP) as component (B) has the CAS reg. no.: 78-51-3 and is described in detail in its further properties under this entry in technical literature.

The content of TBEP (B) in the crop protection agents used in the method according to the invention is dependent on the application rate per unit area, i.e. per hectare (ha) and must therefore be adapted appropriately. This also applies to the preparation of an application solution, for example a spray liquor, with the use of the method according to the invention. The application rates per unit area for TBEP (B) are between 2.5 and 150 g/ha, preferably from 5 to 100 g/ha, particularly preferably from 10 to 100 g/ha, the volume of the spray liquor being as a rule 100-500 l/ha.

If appropriate, the addition of one or more emulsifiers may be necessary as component (C) in the preparation of crop protection agents used in the method according to the invention and/or the application according to the method according to the invention, preferably in the form of spray liquors. Suitable emulsifiers are selected from the group consisting of the ionic and nonionic emulsifiers and mixtures thereof having HLB values of from 10 to 17 (e.g. emulsifier 1371B). They can be added either directly and/or through the formulation of the components (A) and/or (B).

The application rates per unit area of the component (C) in the application of the crop protection agent according to the invention and/or of the process according to the invention is in general between 10 and 200 g/ha, preferably between 20 and 200 g/ha.

All customary formulation auxiliaries, such as organic solvents, antifoams, emulsifiers differing from component (C), dispersants, preservatives, acids and bases, dyes, fillers and also water, are suitable as further auxiliaries and additives (component D) which may be present in the formulations which are preferably liquid according to the method according to the invention.

Suitable organic solvents are all customary organic solvents which readily dissolve the agrochemical active substances used. Aliphatic and aromatic, optionally halogenated hydrocarbons, such as toluene, xylene, Solvesso®, vegetable and mineral oils, such as mineral spirit, petroleum, alkylbenzenes and spindle oil, and furthermore propylene carbonate, tetrachloromethane, chloroform, methylene chloride and dichloromethane, and additionally esters, such as ethyl acetate, lactates and furthermore lactones, such as butyrolactone, and additionally lactams, such as N-methylpyrrolidone, N-octylpyrrolidone, N-dodecylpyrrolidone N-octylcaprolactam and N-methylcaprolactam, γ-butyrolactone, dimethylformamide, and tributyl phosphate, may preferably be mentioned.

Suitable antifoams are customary antifoams present in formulations of agrochemical active substances. Silicone oils, dispersions of silicone oils, magnesium stearate, phosphinic and phosphonic acids, in particular Fluowet PL 80® may be mentioned by way of example.

Suitable emulsifiers differing from component (C) are customary surface-active substances present in formulations of agrochemical active substances. Ethoxylated nonylphenols, polyethylene glycol ether of linear alcohols, alkoxylated linear and branched saturated and unsaturated alcohols which are endcapped and those which are not endcapped, reaction products of alkylphenols with ethylene oxide and/or propylene oxide, ethylene oxide-propylene oxide block copolymers, polyethylene glycols and polypropylene glycols, and furthermore fatty acid esters, alkoxylated linear and branched, saturated or unsaturated fatty acids which are endcapped and those which are not endcapped, alkanesulfonates, alkylsulfates, alkyl ether sulfates, arylsulfates, ethoxylated arylalkylphenols, such as, for example, tristyrylphenol ethoxylate having on average 16 ethylene oxide units per molecule, and furthermore ethoxylated and propoxylated arylalkylphenols and sulfated or phosphated arylalkylphenol ethoxylates or ethoxy- and propoxylates may be mentioned by way of example.

Suitable dispersants are substances usually used in crop protection agents for this purpose. In addition to the compounds mentioned above under emulsifiers differing from component (C), natural and synthetic, water-soluble polymers, such as gelatin, starch and cellulose derivatives, in particular cellulose esters and cellulose ethers, and furthermore polyvinyl alcohol, polyvinylpyrrolidone, polyacrylic acid, ligninsulfonates, polymethacrylic acid and copolymers of (meth)acrylic acid and of (meth)acrylates, and also copolymers of methacrylic acid and methacrylates, which copolymers have been neutralized with alkali metal hydroxide, may preferably be mentioned.

Suitable preservatives are all substances usually present for this purpose in crop treatment agents. Preventol® and Proxel® may be mentioned as examples.

Suitable dyes are all inorganic or organic dyes customary for the preparation of crop protection agents. Titanium dioxide, carbon black, zinc oxide and blue pigments may be mentioned by way of example.

Suitable fillers are all substances usually used for this purpose in crop protection agents. Inorganic particles, such as carbonates, silicates and oxides, having a mean particle size of from 0.005 to 10 μm, particularly preferably from 0.02 to 2 μm, may preferably be mentioned. Silicon dioxide, so-called colloidal silica, silica gels and natural and synthetic silicates and aluminosilicates may be mentioned by way of example.

Suitable compounds which act as emulsion stabilizers and/or crystallization inhibitors are all substances usually used for this purpose in crop protection agents.

The content of the individual components in the crop protection agents used in the methods according to the invention and the application rate per unit area with the use of the method according to the invention can be varied within a relatively large range.

The formulation types suitable for the crop protection agents used in the methods according to the invention and comprising the components (A) and (B) and optionally the components (C) and/or (D) include in principle all formulations which are applied to plants or plant propagation material. The processes used for the preparation thereof are generally familiar to the person skilled in the art and are described, for example, in Winnacker-Küchler, “Chemische Technologie [Chemical Technology]”, volume 7, C. Hanser Verlag Munich, 4th edition, 1986; J. W. van Valkenburg, “Pesticide Formulations”, Marcel Dekker N.Y., 1973, K. Martens, “Spray Drying Handbook”, 3rd Ed. 1979, G. Goodwin Ltd., London, or Mollet, Grubenmann, “Formulierungstechnik [Formulation Technology]”, Wiley-VCH-Verlag, Weinheim, 2000.

In addition, in principle all formulation types are also suitable for the individual components of the method according to the invention.

Examples of formulation types are those mentioned in “Manual on development and use of FAO and WHO specifications for pesticides” (FAO and WHO, 2002, appendix E) (in each case use of the GCPF formulation codes with the English abbreviation and designation): AL Any other liquid; AP Any other powder; CF Capsule Suspension for Seed Treatment; CG Encapsulated granule; CL Contact liquid or gel; CP Contact powder; CS Capsule suspension; DC Dispersible concentrate; DP Dustable powder; DS Powder for dry seed treatment; EC Emulsifiable concentrate; ED Electrochargeable liquid; EG Emulsifiable Granule; EO Emulsion, water in oil; EP emulsifiable powder; ES Emulsion for seed treatment; EW Emulsion, oil in water; FG Fine granule; FS Flowable concentrate for seed treatment; GF Gel for Seed Treatment; GG Macrogranule; GL Emulsifiable gel; GP Flo-dust; GR Granule; GS Grease; GW Water soluble gel; HN Hot fogging concentrate; KK Combi-pack solid/liquid; KL Combi-pack liquid/liquid; KN Cold fogging concentrate; KP Combi-pack solid/solid; LA Lacquer; LS Solution for seed treatment; ME Micro-emulsion; MG Microgranule; OD Oil dispersion; OF Oil miscible flowable concentrate/oil miscible suspension; OL Oil miscible liquid; OP Oil dispersible powder; PA Paste; PC Gel or paste concentrate; PO Pour-on; PR Plant rodlet; PT Pellet; SA Spot-on; SC suspension concentrate; SD suspension concentrate for direct application; SE Suspo-emulsion; SG Water soluble granule; SL Soluble concentrate; SO Spreading oil; SP Water soluble powder; SS Water soluble powder for seed treatment; ST Water soluble tablet; SU Ultra-low volume (ULV) suspension; TB Tablet; TC Technical material; TK Technical concentrate; UL Ultra-low volume (ULV) liquid; WG Water dispersible granules; WP Wettable powder; WS Water dispersible powder for slurry seed treatment; WT Water dispersible tablet; XX Others.

Liquid formulation types are preferred. These include formulation types OD Oil dispersion; DC (GCPF formulation code for dispersible concentrate); EC (GCPF formulation code for emulsion concentrate); EW (GCPF formulation code for oil-in-water emulsion); ES (GCPF formulation code for an emulsion for seed treatment); FS (GCPF formulation code for flowable concentrate for seed treatment); EO (GCPF formulation code for water-in-oil emulsion); ME (GCPF formulation code for microemulsion); SE (GCPF formulation code for suspoemulsion); SL (GCPF formulation code for water-soluble concentrate); CS (GCPF formulation code for capsule suspension) and AL (GCPF formulation code for ready-to-use liquid formulation, other liquids for use in undiluted form).

Oil dispersions (syn. oil dispersion; formulation type OD) and emulsion concentrates (formulation type EC) are particularly preferred.

In spray powders, the active substance concentration is, for example, from about 10 to 90% by weight; the remainder to 100% by weight consists of TBEP (B) and customary formulation constituents (emulsifier, auxiliaries and additives), which is true for all formulations. In the case of emulsifiable concentrates, the active substance concentration may be from about 1 to 90, preferably from 5 to 80, % by weight. Dust-like formulations contain from 1 to 30% by weight of active substance, preferably in general from 5 to 20% by weight of active substance, and sprayable solutions contain from about 0.05 to 80, preferably from 2 to 50, % by weight of active substance. In the case of water-dispersible granules, the active substance content depends in some cases on whether the active compound is present in liquid or solid form and which granulation auxiliaries, fillers, etc. are used. In the case of the granules dispersible in water, the content of active substance is, for example, between 1 and 95% by weight, preferably between 10 and 80% by weight. In the case of oil dispersions, the active substance concentration may be from about 1 to 50, preferably from 3 to 30, % by weight.

The invention furthermore relates to a method for controlling harmful organisms, preferably harmful plants, the components used in the method according to the invention being applied to the harmful plants, preferably in an effective amount.

Furthermore, the invention also relates to a method according to the invention, containing at least the components (A) and (B) which, in a preferred embodiment, show superadditive effects (synergism). Owing to the improved control of the harmful organisms by the methods according to the invention, it is possible to lower the application rate and/or to increase the safety margins. Both are both economically and ecologically expedient. The choice of the amounts of the components (A) and (B) to be used and the ratio of the components (A):(B) are dependent on a whole range of factors.

The preparation of the crop protection agents used in the methods according to the invention is effected, for example, by a procedure in which the components are mixed with one another in the respective desired ratios. If the herbicides and/or safeners, designated below as agrochemical active substances, are a solid substance, they are generally used either in finely milled form or in the form of solution or suspension in an organic solvent or water. If the agrochemical active substance is liquid, the use of an organic solvent is frequently superfluous. It is also possible to use a solid agrochemical active substance in the form of a melt.

While the method is being carried out, the temperatures may be varied within a certain range. In general, temperatures between 0° C. and 80° C., preferably between 10° C. and 60° C., are employed.

For the preparation of the crop protection agents used in the methods according to the invention, in general a procedure is adopted in which TBEP (B) is mixed with one or more of the agrochemical active substances (A) and optionally with the emulsifier (C) and the auxiliaries and additives (D). The sequence in which the components are mixed with one another depends on the respective formulation type.

Customary apparatuses which are used for the preparation of agrochemical formulations are suitable for carrying out the preparation process.

All methods known by a person skilled in the art to be customary can be used as application forms for use of the crop protection agent used in the methods according to the invention and for carrying out the method according to the invention; the following may be mentioned by way of example: spraying, immersion, application as a mist and a number of special methods for direct underground of above-ground treatment of entire plants or parts (seed, root, stolons, stalks, trunk, foliage), such as, for example, trunk injection in the case of trees or stalk bandages in the case of perennial plants, and a number of special indirect application methods.

The respective application rate per unit area and/or per object of the crop protection agents of a very wide range of formulation types which are used in the methods according to the invention and of the method according to the invention for controlling said harmful organisms varies very greatly. In general, the application media known to a person skilled in the art as being customary for the respective field of use are used for this purpose in the customary amounts; such as, for example, several hundred liters of water per hectare in the case of standard spray methods to a few liters of oil per hectare in the case of the ultra low volume aircraft application to a few millimeters of a physiological solution in the case of injection methods. The concentrations of the crop protection agents used in the methods according to the invention in the corresponding application media therefore vary within a wide range and are dependent on the respective field of use. In general, concentrations which are known to the person skilled in the art as being customary for the respective field of use are used. Concentrations of from 0.01% by weight to 99% by weight, particularly preferably from 0.1% by weight to 90% by weight, are preferred.

The crop protection agents of a very wide range of formulation types which are used in the methods according to the invention, as well as the components necessary for carrying out the method according to the invention, can be applied, for example, in the formulation forms customary for liquid preparations, either as such or after prior dilution with water, i.e. for example as emulsions, suspensions or solutions. The application is effected by the customary methods, i.e. for example by spraying, pouring or injection.

The application rate of the crop protection agents of a very wide range of formulation types which are used in the methods according to the invention, as well as the components necessary for carrying out the method according to the invention, can be varied within a relatively large range. It depends on the respective herbicides and/or safeners and on the content thereof in the formulations.

In the method according to the invention for enhancing the penetration of active substances into plants, the TBEP (B) to be used is as a rule applied together with the active substance or substances (A) or directly in succession, preferably in the form of a spray liquor which contains TBEP (B) in amounts according to the invention and the active substance or substances (A) in effective amounts and optionally one or more emulsifiers (C). In addition, further customary auxiliaries and additives can be added. The spray liquor is preferably prepared on the basis of water and/or an oil, for example the high-boiling hydrocarbon, such as kerosene or paraffin. The components for the method according to the invention can be realized either as a tank mix or via a ready-to-use formulation (coformulation).

In the case of herbicides and/or safeners, the application to the harmful plant or crop plant is preferred. Regarding the use of herbicides, the plants treated according to the invention are all types of harmful plants, such as weeds. With regard to the crop plants, the application in economically important, for example including transgenic, crops of useful and ornamental plants, for example of cereals, such as wheat, barley, rye, oats, millet, rice, cassaya and corn, or crops of peanuts, sugar beet, cotton, soybean, rape, potato, tomato, pea and other vegetable varieties is preferred.

The crop protection agents used in the methods according to the invention, and the methods according to the invention, have a number of advantages. Thus, the general penetration of the active substances into the plant tissue is substantially improved by TBEP. The faster onset of penetration thus also results in a higher resistance to rain. At the same time, the penetration at relatively low temperatures (for example less than 15° C.) is improved. With regard to the crop plant tolerance, TBEP proved to be more tolerant than other alkyl ester additives in tests. Overall, use of TBEP therefore permits savings of the active substances used. In addition, TBEP results in less environmental pollution since it has reduced volatility.

The invention is illustrated in more detail by the examples without limiting them thereto.

### EXAMPLES

### Penetration Test

In this test, the penetration of active substances through enzymatically isolated cuticles of apple tree leaves was measured. The cuticles represent all green plant parts, such as leaf blade, petiole, stalk, trunk, hypocotyl and many fruits.

Leaves which were cut off in the stage of full development of apple trees of the Golden Delicious variety were used. The isolation of the cuticles was effected in a manner such that
first, leaf disks marked on the underside with dye and punched out were filled by means of vacuum infiltration with a pectinase solution (0.2 to 2% strength by weight) buffered to a pH between 3 and 4,
sodium azide was then added and
the leaf disks thus treated were allowed to stand until disintegration of the original leaf structure and detachment of the noncellular cuticle.

Thereafter, only those cuticles of the upper sides of the leaves which were free of stomata and hairs were further used. They were washed several times alternately with water and a buffer solution at pH 7. The cleaned cuticles obtained were finally drawn onto small Teflon plates and smoothed and dried with a gentle air jet.

In the next step, the cuticle membranes thus obtained were placed in stainless steel diffusion cells (=transport chambers) for membrane transport investigations. For this purpose, the cuticles were placed by means of forceps centrally on the silicone grease-coated edges of the diffusion cells and closed with a likewise greased ring. The arrangement was chosen so that the morphological outside of the cuticles faced outward, i.e. toward the air, while the original inside faced the interior of the diffusion cell. The diffusion cells were filled with water or with a mixture of water and solvent.

For determining the penetration, in each case 10 μl of a spray liquor of the composition mentioned in the examples were applied to the outside of a cuticle.

In each case the solvents listed below in the table (tap water or a mixture with 20% by weight of acetone/80% by weight of tap water) were used in the spray liquors.

After the application of the spray liquors, in each case the solvent was allowed to evaporate, and in each case the chambers were then turned around and placed in thermostated trays, air having a defined temperature and atmospheric humidity being blown onto the outside of the cuticle. The incipient penetration therefore took place at a relative humidity of 60% and a set temperature of 20 or 25° C. The active substance penetration was measured with radioactively marked active substance.

TABLE 1
Enhancement of penetration of various herbicides and
safeners* by TBEP in comparison with the control

| | % Penetration | % Penetration | |
|---|---|---|---|
| Active substance without/with TBEP | (after hours)** | (after hours)** | |
| Safener | 1.7 (3) | 17.4 | (24) |
| 0.2 g/l of isoxadifen-ethyl (A) | | | |
| 0.2 g/l of isoxadifen-ethyl (A) + | 26.5 (3) | 73.1 | (24) |
| 0.5 g/l TBEP (B) | | | |
| Safener | 0.4 (3) | 4.9 | (24) |
| 0.2 g/l of mefenpyr-diethyl (A) | | | |
| 0.2 g/l of mefenpyr-diethyl (A) + | 3.4 (3) | 25.5 | (24) |
| 0.5 g/l TBEP (B) | | | |
| Safener | 0.1 (3) | 0.3 | (24) |
| 0.2 g/l of cyprosulfamide (A) | | | |
| 0.2 g/l of cyprosulfamide (A) + | 5.7 (3) | 10.2 | (24) |
| 0.5 g/l TBEP (B) | | | |
| Herbicide (growth regulator) | 0.6 (6) | 0.9 | (24) |
| 0.2 g/l of thidiazuron (A) | | | |
| 0.2 g/l of thidiazuron (A) | 74.4 (6) | 93.1 | (24) |
| with 3 g/l TBEP (B) | | | |

*Active substance dissolved in a mixture of acetone/tap water (20/80% by weight);
**Mean values of 4-8 repetitions for the penetration through apple leaf cuticles (temperature = 20-25° C., rel. humidity 56-60%); isoxadifen-ethyl (manufacturer Bayer CropScience), mefenpyr-diethyl (manufacturer Bayer CropScience), cyprosulfamide (4-cyclopropylaminocarbonyl-N-(2-methoxybenzoyl)benzenesulfonamide, manufacturer Bayer CropScience), thidiazuron (manufacturer Bayer CropScience).

As is evident from the examples shown in table 1, TBEP leads to a considerable increase in uptake of the active substances.

TABLE 2
Comparative experiments for different compounds as penetration
enhancers of the herbicidal active substances fenoxaprop-P-ethyl*

| Active substance without/with | % Penetration | % Penetration |
|---|---|---|
| penetration enhancer*** | (after 24 hours)** | (after 48 hours)** |
| Herbicide | 0.3 | 0.9 |
| 0.3 g/l of fenoxaprop-P-ethyl (A) | | |
| 0.3 g/l of fenoxaprop-P-ethyl (A) + | 66 | 76 |
| 2.0 g/l TBP (B) | | |
| 0.3 g/l of fenoxaprop-P-ethyl (A) + | 10 | 22 |
| 2.0 g/l TPP (B) | | |
| 0.3 g/l of fenoxaprop-P-ethyl (A) + | 77 | 86 |
| 2.0 g/l TBEP (B) | | |

*Active substance dissolved in a mixture of acetone/tap water (20/80% by weight);
**Mean values of 10 repetitions for the penetration through apple leaf cuticles (T = 20-25° C., rel. humidity 56-60%); fenoxaprop-P-ethyl (manufacturer Bayer CropScience);
***TBP = tributyl phosphate and TPP = tripropyl phosphate (prior art: EP 579052 A2); TBEP = tributoxyethyl phosphate (according to the invention).

As is evident from the examples shown in table 2, the TBEP according to the invention leads to an advantageously higher increase in uptake of active substances than the penetration enhancers of the prior art. This result is surprising and was not to be expected in view of the prior art.

1. A method for enhancing penetration of an agrochemical active compound in a plant, said method comprising applying,
(A) at least one active substance selected from the group consisting of the herbicides and safeners,
(B) tributoxyethyl phosphate (TBEP) in an amount of from 2.5 to 150.0 g/ha and
(C) optionally one or more emulsifiers,
wherein said components (A), (B) and optionally (C) are applied simultaneously and/or sequentially to a harmful plant.

2. A method as claimed in claim 1, wherein the components A, B, and C are applied simultaneously or sequentially to a harmful plant.

3. A method for controlling harmful organisms comprising
employing, the method as claimed in claim 1.

4. A combination for enhancing penetration of an agrochemical compound comprising:
(A) at least one active substance selected from the group consisting of herbicides and safeners,
(B) tributoxyethyl phosphate (TBEP) in an amount of from 2.5 to 150.0 g/ha and
(C) optionally one or more emulsifiers.

5. A method of claim 1, wherein said emulsifier is at least one selected from the group consisting of ionic and nonionic emulsifiers having an HLB value of from 10 to 7.

6. A method of claim 2, wherein said emulsifier is at least one selected from the group consisting of ionic and nonionic emulsifiers having an HLB value of from 10 to 7.

7. A method of claim 3, wherein said emulsifier is at least one selected from the group consisting of ionic and nonionic emulsifiers having an HLB value of from 10 to 7.

8. A combination of claim 4, wherein said emulsifier is at least one selected from the group consisting of ionic and nonionic emulsifiers having an HLB value of from 10 to 7.
